(19) United States
(12) Patent Application Publication
(10) Pub. No.: US 2013/0326025 A1
(43) Pub. Date: Dec. 5, 2013

(54) System and Method for Differentiating and Calculating Royalties for Copyright-Protected Song Samples Used by Artists in New Works

(71) Applicant: Mile Newbold Clark, New Orleans, LA (US)

(72) Inventor: Mile Newbold Clark, New Orleans, LA (US)

(21) Appl. No.: 13/895,323

(22) Filed: May 15, 2013

Related U.S. Application Data
(60) Provisional application No. 61/647,913, filed on May 16, 2012.

(51) Int. Cl. H04L 29/08

(52) U.S. Cl. CPC H04L 67/02
USPC 709/219

(57) ABSTRACT

A method is disclosed for calculating the value a “sample” of a copyright-protected work of art adds when included in a new work. The method is embodied in a computer program or series of computer programs, available from a web portal linked to a server, which stores relevant information about an owner's “samples;” allows the owner to assign specific value criteria to all “samples;” allows an artist to download specified “samples,” incorporate them into new works, and upload the new works to the web portal, where a series of calculations then derive the value each “sample” adds to the new work; and creates conditions obligating the artist to upload information regarding the distribution of the new work to the web portal so the value added by each “sample” can be distributed to the “sample” owners in proportion to the value each “sample” adds to the new work.

### CROSS-REFERENCE TO RELATED APPLICATIONS

Provisional Utility Patent Application No. 61647913, EFS ID 12797089, Filed May 16, 2012

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Technical Field

The method and system described herein relate to the field of copyright law, specifically the storage, downloading, and use of particular “samples” of copyright-protected digital audio media, as well as the valuation of a subsequently created audio media by a third party and the accounting of sales of the new audio media. The desired inputs for deriving this “value” are the disaggregated “samples” of an audio recording, and the artist's original digital audio creating which makes use of selected “samples.” These desired inputs are intended as one illustration of the method, but are not the exclusive illustration of the method.

2. Description of the Related Art—In General¹ This Description of the Related Art cites several proper names that are or may be trademarked: “Vanilla Ice,” “Ice Ice Baby,” “Queen,” “David Bowie,” “Under Pressure,” “Beastie Boys,” “Finger Lickin' Good,” “Bob Dylan,” “Just Like Tom Thumbs Blues, and “Paul's Boutique.” All rights reserved to the copyright owners.

In the music world, an artist's insertion of small portions of previously recorded audio material into new songs is known as “sampling.” “Sampling” is often relied upon in pop music recordings to achieve aesthetic effect. “Sampling” is arguably distinguishable from outright theft because it involves use of either a limited number of musical elements from a copyright-protected work, or use of all of the work's prior musical elements for a selection of the entire song. An example of the first type of “sampling” occurs in Vanilla Ice's song “Ice Ice Baby,” which used an underlying bassline which was identical, or nearly identical, to the underlying bassline from Queen and David Bowie's copyright-protected song “Under Pressure.” An example of the second type of “sampling” occurs in the Beastie Boys' song “Finger Lickin' Good,” which uses several full seconds of Bob Dylan's song “Just Like Tom Thumb's Blues” near the end of the track.

The use of “sampling” can achieve a comprehensive aesthetic effect. For example, one of the Beastie Boys' most distinct and well-received albums, “Paul's Boutique,” allegedly contains samples of over 100 previously copyright-protected works. Critics have often remarked that this album, whose compilation of rapid-fire recollections create a unique and innovative pastiche, can likely never be remade in today's intellectual property climate, because while “sampling” was once largely considered “fair use,” it is now largely considered to be infringement. Therefore, “sampling” has become prohibitively expensive, and while it is still widely practiced in live DJ events, it is no longer used as extensively in recorded audio media. This has had profound impacts on the aesthetic trajectory of electronic and hip-hop music; moreover, in a digital world increasingly governed by fixed reference points, the inability to “sample” has impacted music's immediate relevance to the day-to-day lives of listeners.

Intellectual property protections allow artists and others to secure a reliable profit stream from creative work, and copyright-owners have an unquestioned right to protect their inventions from appropriation. While it is always possible to license use of a “sample” from the copyright-holder, negotiation of license agreements for songs is often cumbersome and inefficient. And because protection of intellectual property from infringement uses traditional judicial process, enforcement of copyright protections poses similar impediments. Such legal confrontations can prove especially daunting for up-and-coming artists, whose aesthetic credos create a legitimate need to “sample” previously existing work, but who may be unprepared for legal challenges when infringement, even unintentional infringement, occurs.

The system and method described herein provide a means to streamline and internalize the costs of copyright protection and license agreements, by permitting an artist to make use of “samples” of pre-existing work with the permission of the copyright-owners, in exchange for a stream of revenue from any sales of that work. In brief, the preferred embodiment of the system and method described in this Specification provides the following: (1) The individual components of copyright-protected works are disaggregated into “samples” and uploaded to an internet-accessible web portal. (2) The copyright-holder assigns a value to each “sample.” (3) The valued “samples” are made available to artists after the owner signs certain forms. (4) Artists, accessing the web portal, can browse the various “samples,” listen to them, and then select them for download. (5) The artist downloads the “samples” and uses them in his or her new musical composition. (6) The artist uploads a copy the new musical composition to the server, the application performs a search of artist's new musical composition, and searches for signatures attached to each “sample.” (7) the application returns a value to the artist, both in terms of the value of all “samples” used in the new musical composition, and as discrete royalty payments owed to each copyright-holder. (8) Should the artist choose to proceed in selling the new musical composition, the artist signs a license agreement, agreed to by the copyright-holder by reference, which requires submission of some form of invoices to the copyright-holder reflecting the number of sales of the copies of the song which are sold, which reflect the royalty payment. Note that this is only one generalized potential embodiment of many separate ways by which “samples” can be valued and licensed to others, particularly up-and-coming artists. Many others within the scope of the claimed invention exist, which a person of ordinary skill in the art would appreciate.

The system and method of the preferred embodiment of the present invention assists the artist in several ways. First, it will provide freedom for wide-ranging artistic experimentation without the fear of being subjected to litigation. This is especially important for more ambitious artists who may be interested in signing with record labels, who in turn presumably have somewhat deeper pockets, are not “judgment proof,” and may more closely scrutinize artists who have been subject to copyright infringement suits.

Second, because the system and method of the preferred embodiment is premised upon royalty payments which accrue upon sale of a completed work—or at the very least, no up-front payment prior to the artist's completion of the song—it does not impose undue costs on the artist during the process of composition. Until recently, the transaction costs involved in disaggregation, valuation, and accounting for the use of the “sample” would have itself incurred insurmountable transaction costs; however, given the modern ease by which digital transactions are tracked, and the ability of computer software to automate the accounting and valuation processes, such costs can now be internalized and the process of valuation rendered feasible today. While some human guesswork obviously arises in connection with how various “samples” of a work should be valued, even this can be internalized and automated to a large degree. Moreover, the flexible method for valuation described herein will result in rich experimentation and ultimately to drastically lower transaction costs.

Third, because the artist can view a potential range of “sample” valuations prior to download and use, the system and method described herein can also provide valuable information to the artist about which portions of the Content Owners find particularly valuable. The Artist will be able to view different creations and choose to pursue those which prove especially cost-effective.

The copyright-holder benefits from this system and method in several ways. First, it is typically only the “complete” song, i.e., all song elements combined, which a consumer expects to purchase. The complete song is thus far more commercially valuable than the sum of its parts. As previously noted, however, “sampling” involves only fragments of the completed work—either the use of a single element of a song, or a short segment of the complete song. These fragments have greatly diminished commercial value to the copyright-holder, but can be an invaluable resource for the aspirant artist. Therefore, although the preferred embodiment provides an option to flexible and nuanced potential method for valuation, such “samples” are more likely susceptible to routine, automated valuation by the copyright-owner; by extension, the widespread dissemination of “samples,” if managed in such a way as not to damage the “brand” of the completed product, will not only result in any loss of revenue from the original, but will create an entirely new revenue stream for copyright-holders in which almost all costs have been internalized through automation.

Second, and recalling the example of Vanilla Ice's “Ice Ice Baby” above, selective and limited “sampling” within a spectrum of risk acceptable to the copyright-holder could ultimately reinforce the strength of an existing copyright holder's completed work. Copyright protections have been expanded to include “samples” in part because such “samples” unequivocally recall the original signature. By extension, a purchaser of the artist's new work who enjoys the “samples” contained therein may also recall elements of the prior work which they found pleasurable. In a similar manner as automakers sell cars in part through advertisements, widespread “sampling” could result in higher sales of the copyright-holder's protected, completed work from which the “sample” was derived.

Third, because the disaggregated “samples” are subject to various protective steps before an artist uses them in an original work, the copyright-owner has complete control over the extent of any particular use. For example, the holder could set an upper “limit” on the amount of a particular work that can be either downloaded and/or ultimately “used” by any individual artist or used in an individual song; use in excess of the authorized limit could result in penalties levied on the artist, though more likely would result in the artist's inability to “verify” the new song through the web portal and trigger the steps required to generate a stream of royalty payments from the artist to the copyright-holder.

Fourth, holders of music copyrights profit only when they create works which people enjoy and are willing to purchase. An understanding of what, exactly, is intellectual pleasurable to human beings is a profoundly inexact science; however, the granulated dissemination of “samples,” and the opportunity to see what artistic innovators find useful, will assist copyright-owners in understanding which elements of their intellectual property are most important in valuing their completed works going forward.

Fifth, this system and method also provides a swift, easy pre-finalization “screening” of an artist prior to allowing the artist to present the song to the consumer market for profit. This ensures one of the most valuable rights possessed by the owner of a creative copyright: the power to control how and where their work is used. “Screening” will vary widely depending on the nature of the artist's prospective use, but subjecting this pre-selection process to automation is far more efficient than the cumbersome, one-on-one interactions which still predominate today.

3. Description of the Related Art—Specific

Many patents have introduced methods and systems for protecting digital audio media which is introduced to an online environment. A number of patents have described methods and systems for secure transfer and tracking of individual, stand-alone pieces of music through digital media. Other patents describe methods by which such transfers can be monetized. Still more patents discuss methods and systems for detection of infringing data by analyzing a distinct set of conditions from an independent source against an original file (for example, a radio station's broadcast of a particular audio file is compared against a database of copyright-protected works). Still other patents describe a system by which a “mashup” recording—i.e., the process of putting two songs together—is disaggregated and the distinct songs are identified for, among other things, potential copyright violations. Moreover, it is common practice for music DJs in other countries like Canada, the United Kingdom, and Finland to acquire “digital licenses” for public performances which involve “sampling” from copyright-protected works. In these systems, a DJ registers with a centralized agency, which issues a time-limited license allowing the DJ to download a selection of digital songs from a central repository. The DJ can then “sample” those songs in the course of public performances during the duration of the license.

The current system and method is distinct from all of the above described inventions for several reasons. First, while this method and system provide a means for secure transfer of material, that material is not tracked, but made subject to an eventual re-uploading by the artist. Second, its uploading and downloading platform are designed to facilitate transfer of distinct parts of a song; the fact that the “completed” work is also uploaded to the server is merely a reference tool, and is not strictly necessary. Third, the “monetized” element of the transaction does not occur at the point of download, but at the time the artist uploads a completed original work containing one or several “samples” contained in the database. Fourth, while distinct parts of an audio recording are disaggregated and marked for later evaluation, such marking occurs at the beginning of the transaction process, and its primary purpose is not to protect against infringement, but to provide means by which an eventual valuation can occur. Finally, the system and method described herein do not relate to live audio performances, but instead to recorded audio which is sold, presumably, through digital channels. Although the system and method does not contemplate deriving a percentage of revenue from live performance of songs containing one or several “samples,” many definitions of “sale” are possible and certainly encompass more than simple sale of the digital audio media. Ultimately, what distinguishes this system and method from other patents is the manner by which it allows downloading of pre-selected “samples” for use in an artistic work, a means of providing a streamlined valuation of those samples as embedded in the artist's created work, and a means of providing a revenue stream from the use of those samples. In sum, this system and method is a means for establishing a largely automated economic relationship between an artist and a copyright-owner, instead of being a method which allows one party to track, evaluate, or enforce his or her rights in certain media.

### BRIEF SUMMARY OF THE INVENTION

The preferred embodiment of the system and method described in this Specification provides the following: (1) The individual components of copyright-protected works are disaggregated into “samples” and uploaded to an internet-accessible web portal. (2) The copyright-holder assigns a value to each “sample.” (3) The valued “samples” are made available to artists after the owner signs certain forms. (4) Artists, accessing the web portal, can browse the various “samples,” listen to them, and then select them for download. (5) The artist downloads the “samples” and uses them in his or her new musical composition. (6) The artist uploads a copy the new musical composition to the server, the application performs a search of artist's new musical composition, and searches for signatures attached to each “sample.” (7) the application returns a value to the artist, both in terms of the value of all “samples” used in the new musical composition, and as discrete royalty payments owed to each copyright-holder. (8) Should the Artist choose to proceed in selling the new musical composition, the Artist signs a license agreement, agreed to by the copyright-holder by reference, which requires submission of some form of invoices to the copyright-holder reflecting the number of sales of the copies of the song which are sold, which reflect the royalty payment.

### BRIEF DESCRIPTION OF THE SEVERAL VIEWS OF THE DRAWING

Attached to this application hereto are rough Figures of the preferred embodiment, which give a general sketch of how different parts of the system and method work together. These Figures are consecutively numbered for each step of the preferred embodiment.

Please note that access to the internet is assumed in all Figures and has not been represented. Also note that directional arrow lines have been provided when necessary. Arrows which point in two directions between two boxes indicates that a process was both sent from, and received to, that box. Also note that in almost every case, the boxed text elements used to describe each sub-part of each step build cumulatively from the beginning to the end of the step; the borders of boxed text elements have been widened from 0.75 width to 1.50 width when describing a “live” element in the depicted step-subset. In some steps and step-subsets, boxed text elements were moved slightly, or deleted, when they caused undue confusion.

Please also note that in several of the Figures which refer to information in the Owner or Artist's respective files, only the information pertinent to that step is listed in the appropriate box. For example, FIG. 6 lists “Terms of Service—Y+Owner Profile+Original Work+Sample” in the Owner file box, whereas FIG. 7 lists only “Original Work+Sample” in the Owner file box. This is because, in FIG. 7, only the Original Work and Sample information are “active” pieces in the step described in FIG. 7.

Please also note that in several steps, typically those in which one or several values are assigned, all of the step elements are not shown in the textual material above each Figure, but are represented, either in whole or in summary form, in the Figure itself. An example of this is in FIG. 7, which describes in part the process by which an Owner assigns a contingent Verification value. Another example of this is FIG. 8, which describes in part the process by which an Owner assigns an Initial Value; here, the sub-steps are described as “inputs” for the sake of ease, and the prior steps used to arrive at the contingent Verification value in FIG. 7 have been removed.

FIG. 1 correlates with step (1), step-subset (1) of the preferred embodiment.

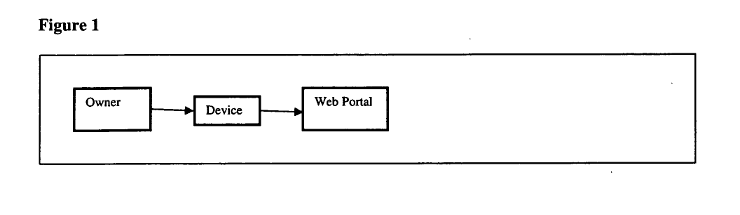

FIG. 2 correlates with step (1), step-subset (2) of the preferred embodiment.

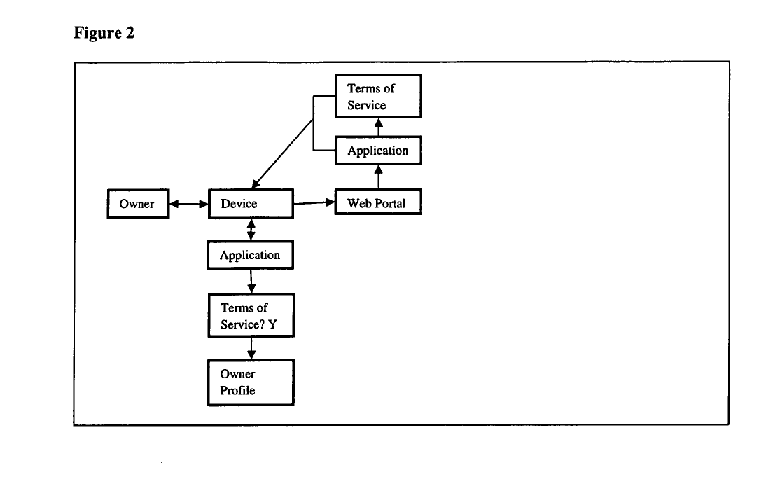

FIG. 3 correlates with step (1), step-subset (3) of the preferred embodiment.

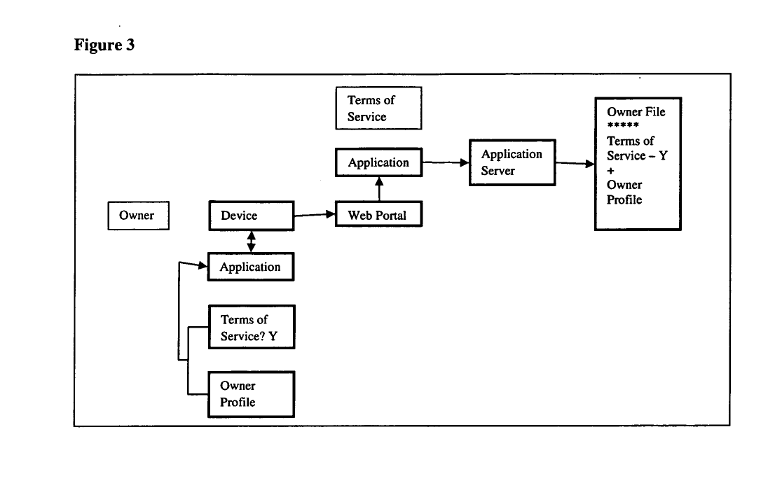

FIG. 4 correlates with step (1), step-subset (4) of the preferred embodiment.

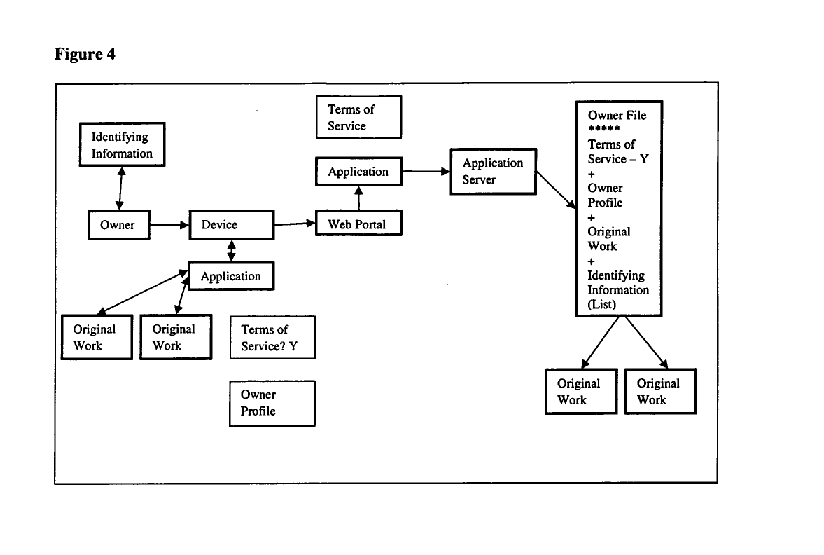

FIG. 5 correlates with step (1), step-subset (5) of the preferred embodiment.

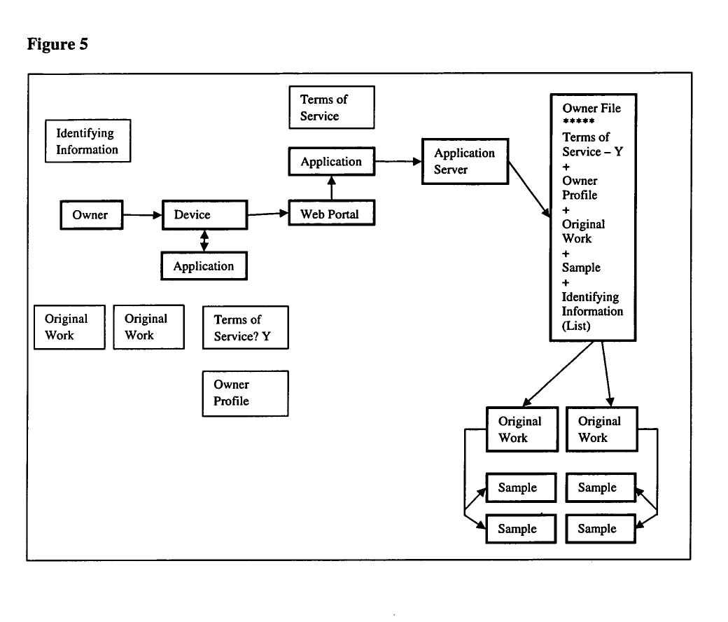

FIG. 6 correlates with step (2), step-subset (1) of the preferred embodiment.

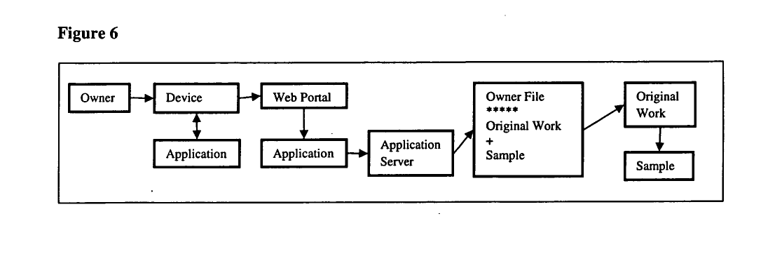

FIG. 7 correlates with step (2), step-subset (2)(a)-(b) of the preferred embodiment.

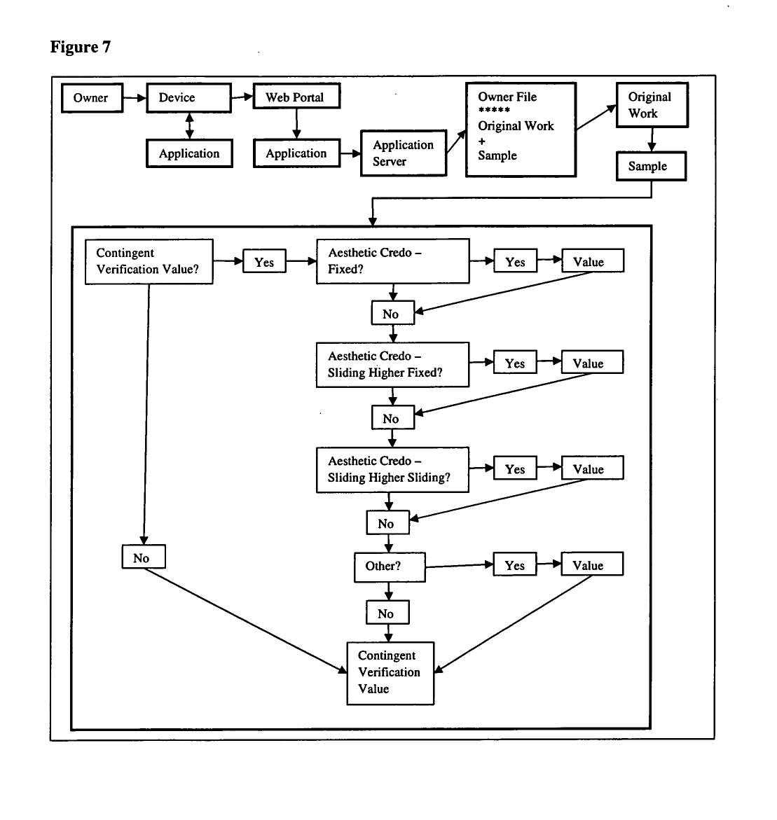

FIG. 8 correlates with step (2), step-subset (3)(I)-(III) of the preferred embodiment.

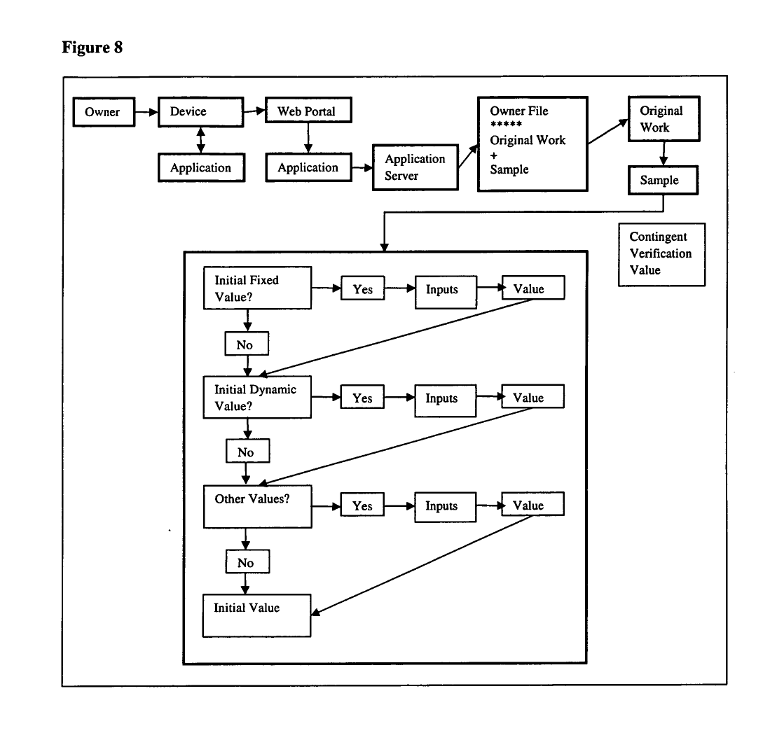

FIG. 9 correlates with step (2), step-subset (4) of the preferred embodiment.

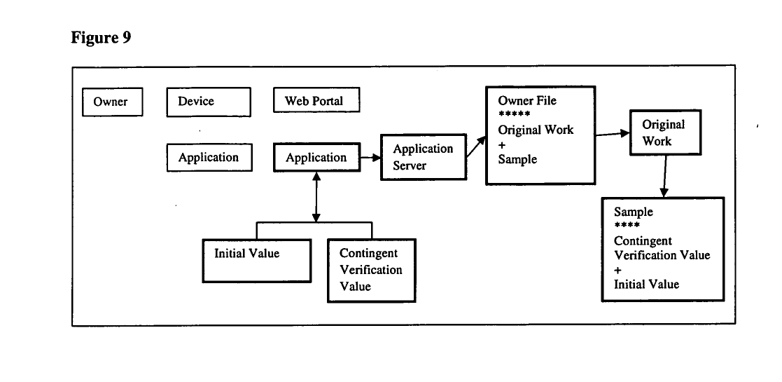

FIG. 10 correlates with step (3), step-subset (1) of the preferred embodiment.

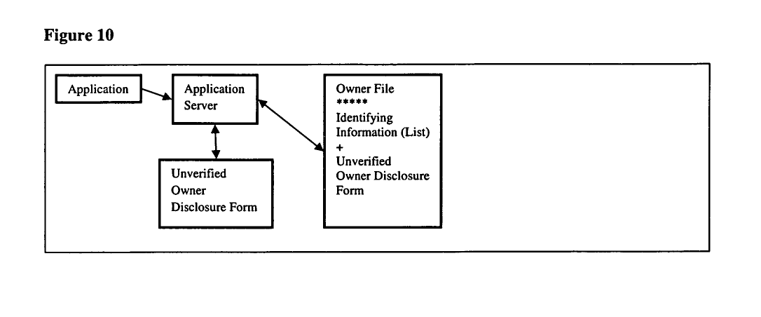

FIG. 11 correlates with step (3), step-subset (2) of the preferred embodiment.

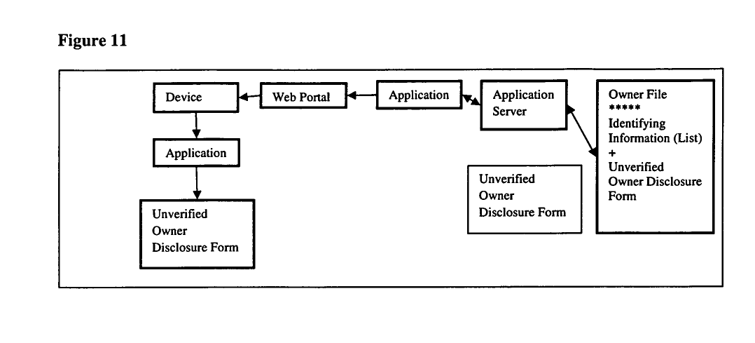

FIG. 12 correlates with step (3), step-subset (3) of the preferred embodiment.

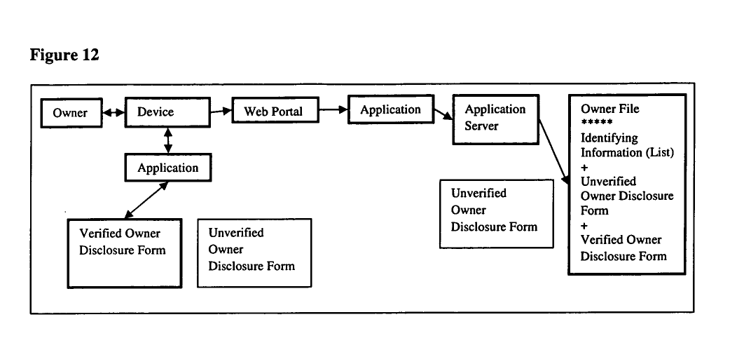

FIG. 13 correlates with step (3), step-subset (4) of the preferred embodiment.

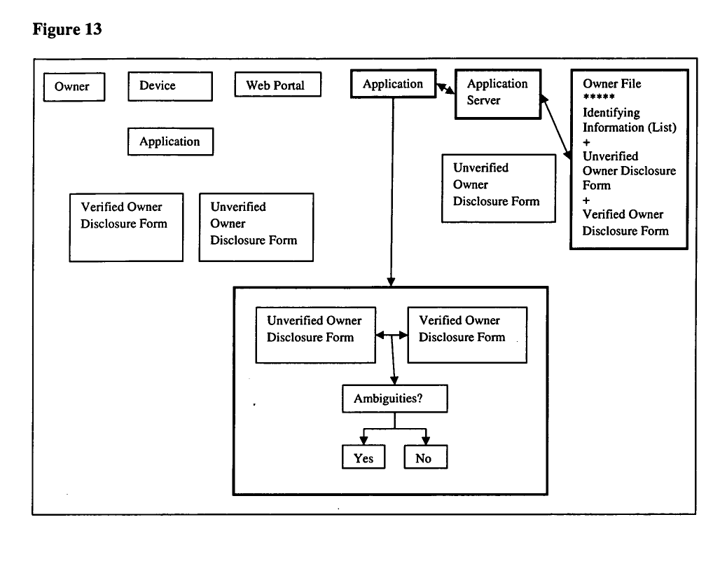

FIG. 14 correlates with step (3), step-subset (5) of the preferred embodiment.

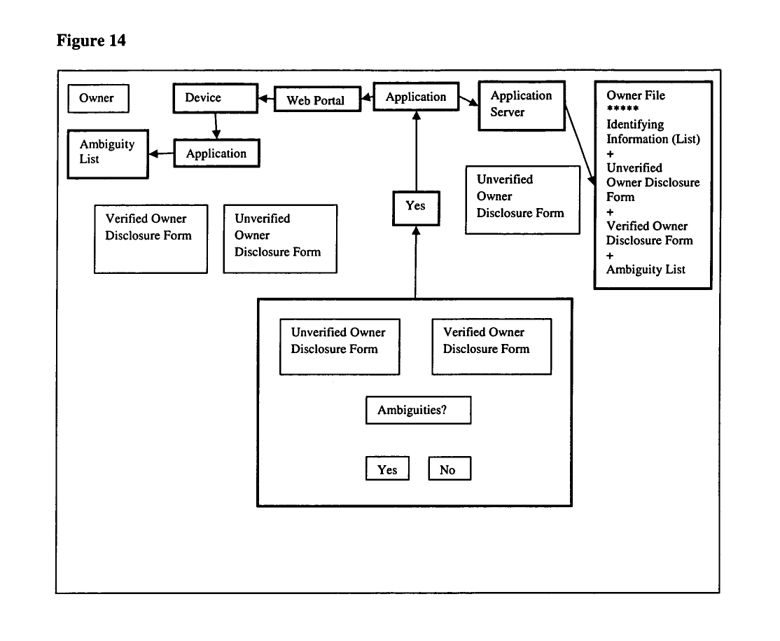

FIG. 15 correlates with step (3), step-subset (6) of the preferred embodiment.

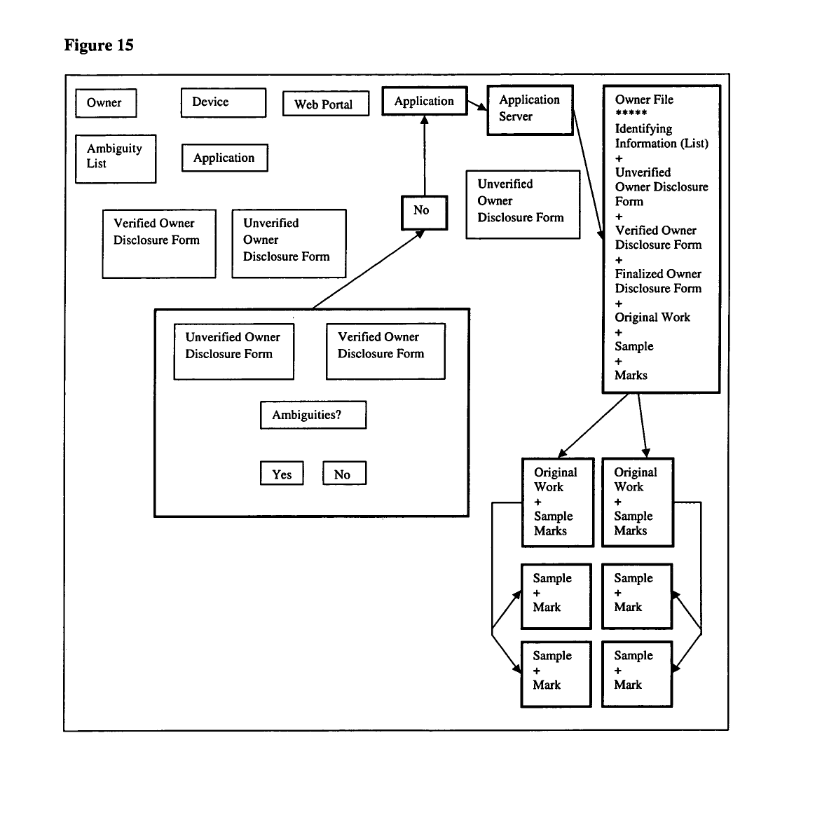

FIG. 16 correlates with step (3), step-subset (7) of the preferred embodiment.

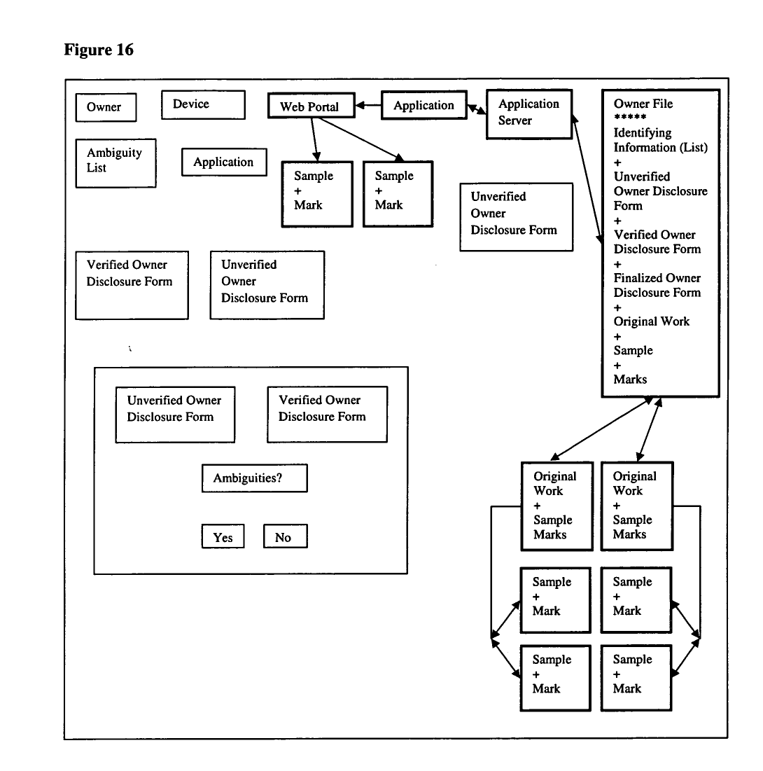

FIG. 17 correlates with step (4), step-subset (1), step-sub-subset (a) of the preferred embodiment.

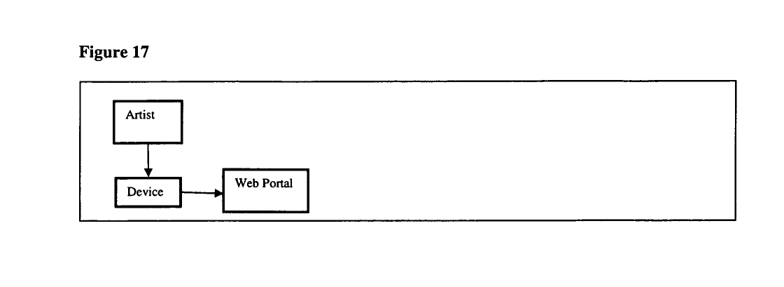

FIG. 18 correlates with step (4), step-subset (1), step-sub-subset (b) of the preferred embodiment.

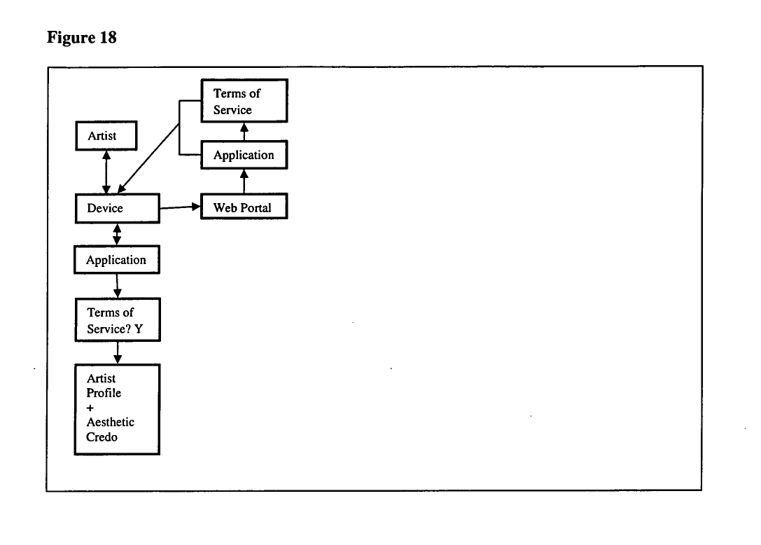

FIG. 19 correlates with step (4), step-subset (1), step-sub-subset (c) of the preferred embodiment.

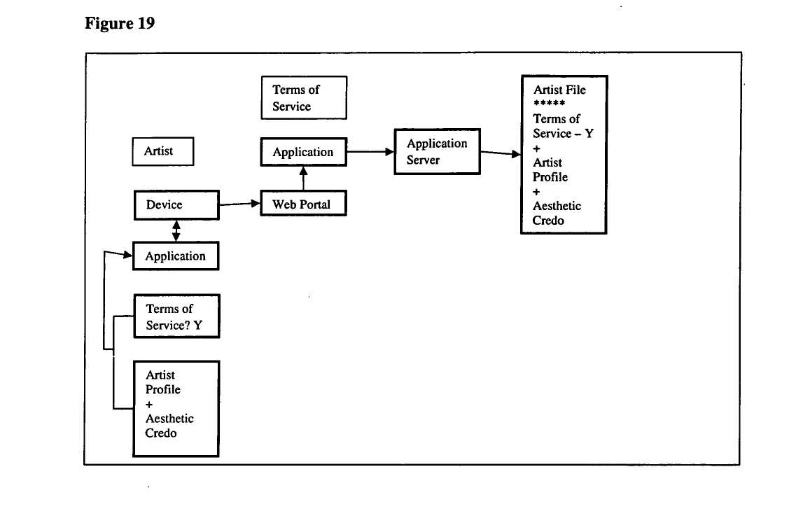

FIG. 20 correlates with step (4), step-subset (1), step-sub-subset (d) of the preferred embodiment.

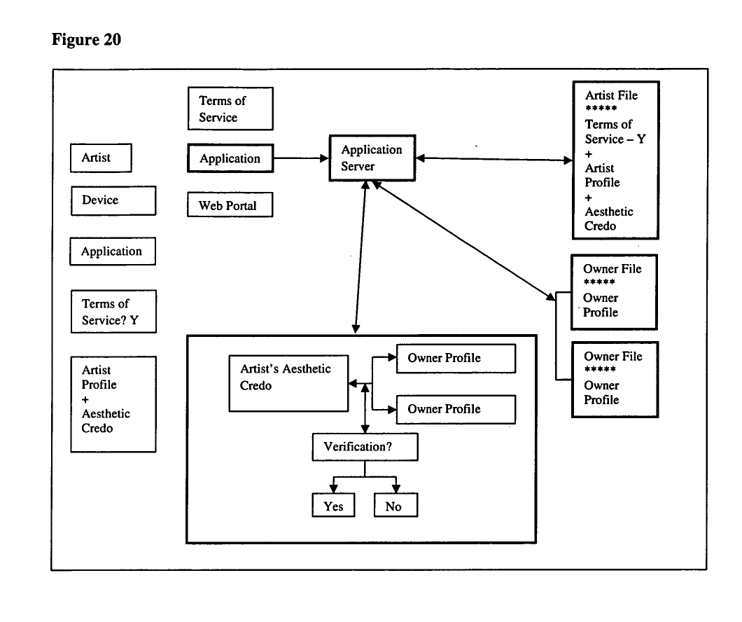

FIG. 21 correlates with step (4), step-subset (1), step-sub-subset (e) of the preferred embodiment.

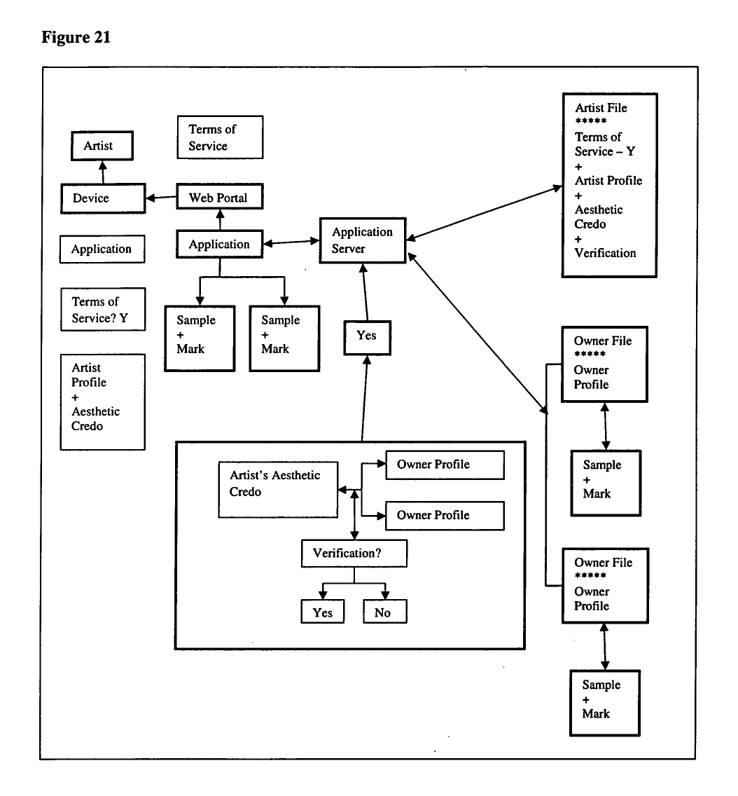

FIG. 22 correlates with step (4), step-subset (2), step-sub-subset (a) of the preferred embodiment.

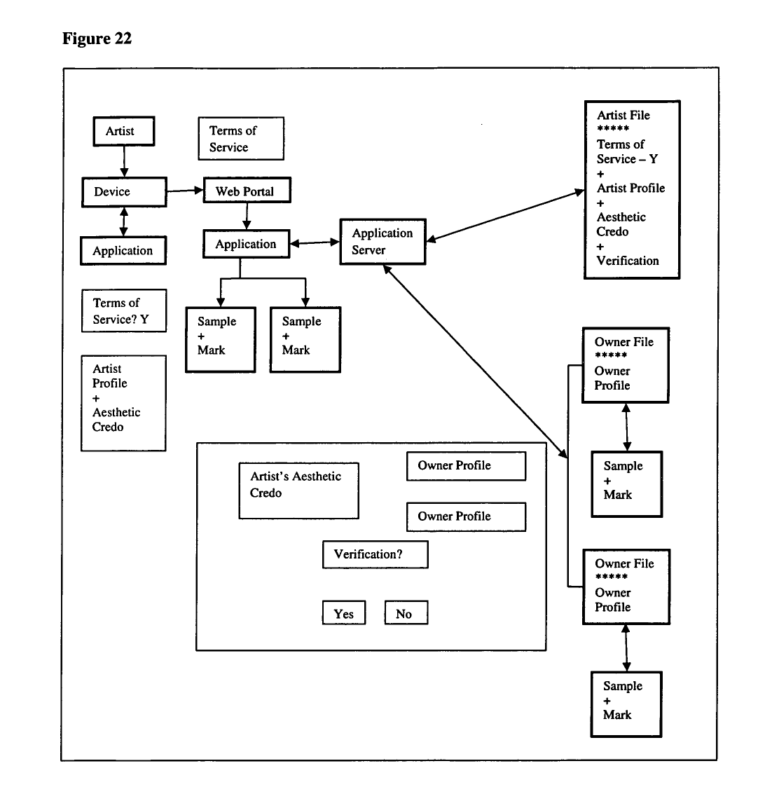

FIG. 23 correlates with step (4), step-subset (2), step-sub-subset (b) of the preferred embodiment.

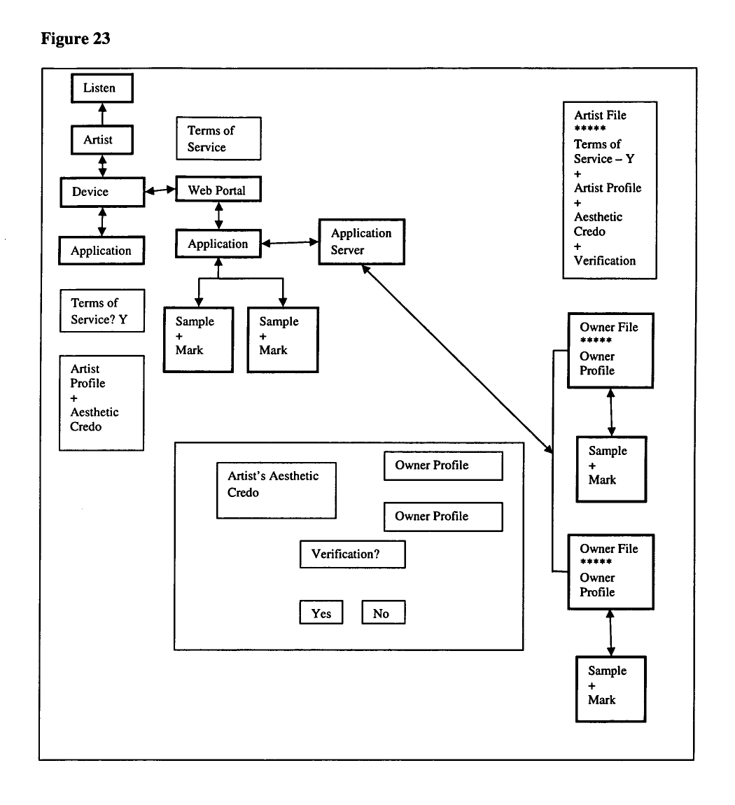

FIG. 24 correlates with step (5), step-subset (1) of the preferred embodiment.

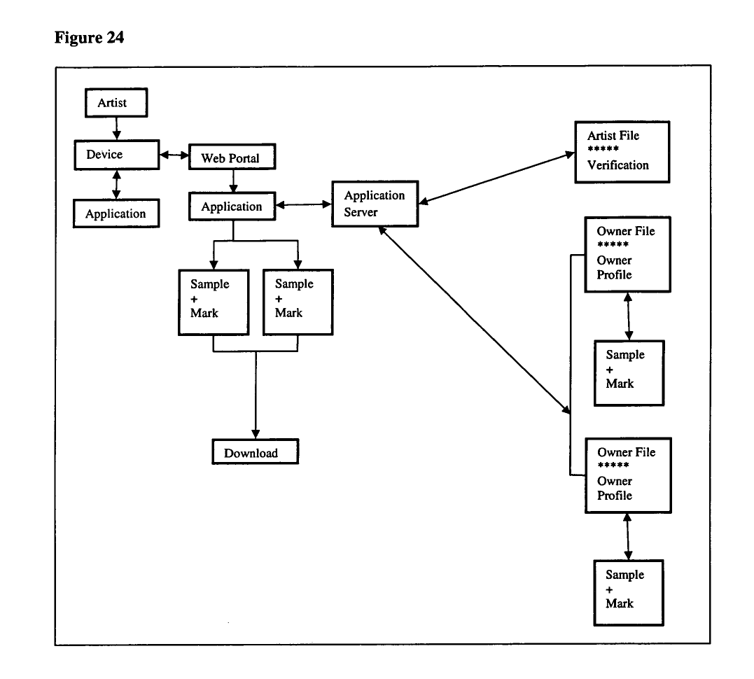

FIG. 25 correlates with step (5), step-subset (2) of the preferred embodiment.

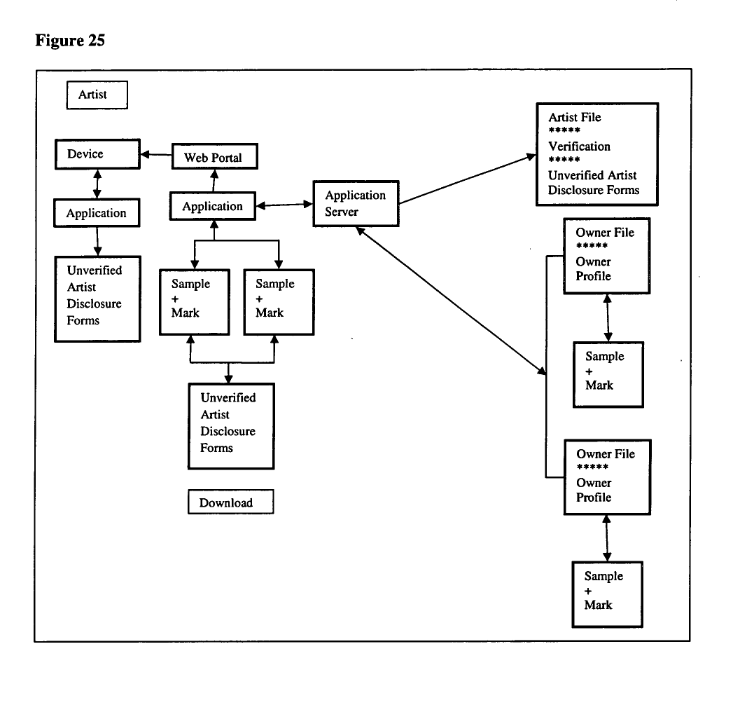

FIG. 26 correlates with step (5), step-subset (3) of the preferred embodiment.

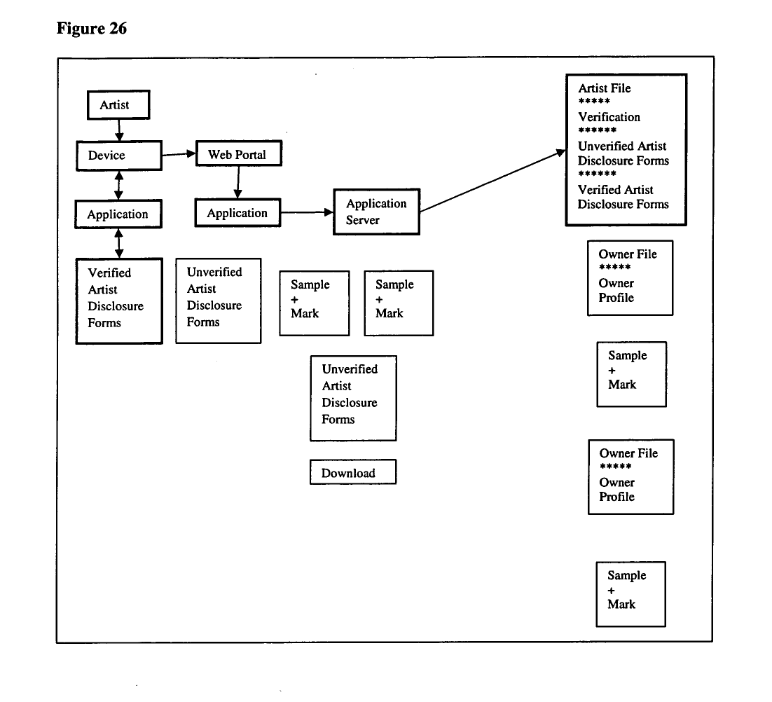

FIG. 27 correlates with step (5), step-subset (4) of the preferred embodiment:

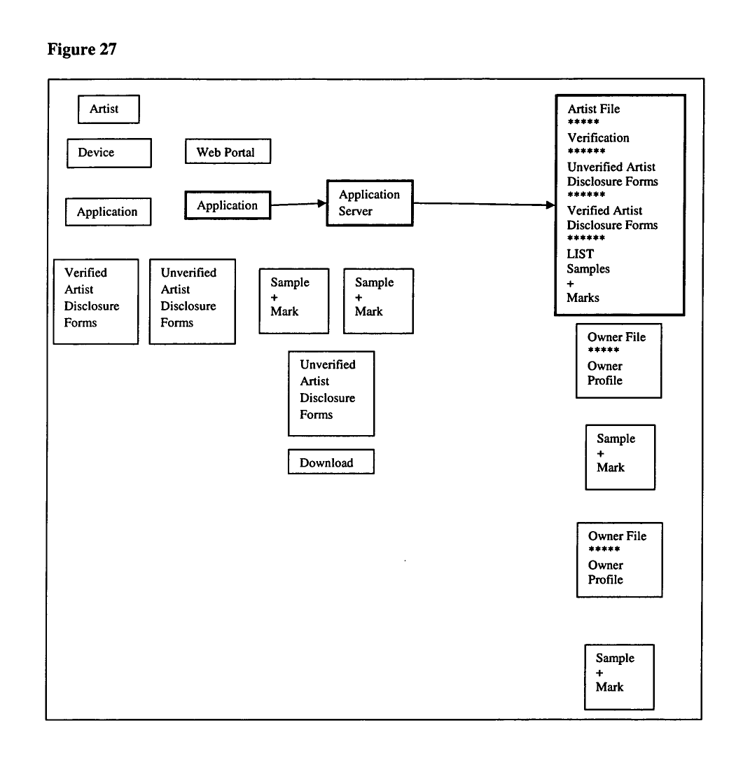

FIG. 28 correlates with step (5), step-subset (5) of the preferred embodiment.

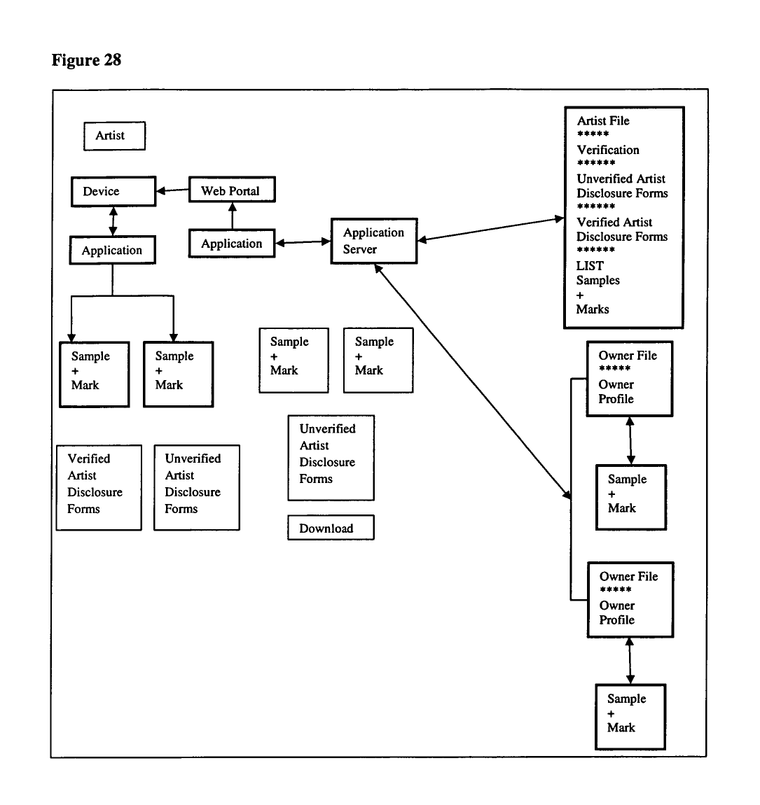

FIG. 29 correlates with step (5), step-subset (6) of the preferred embodiment.

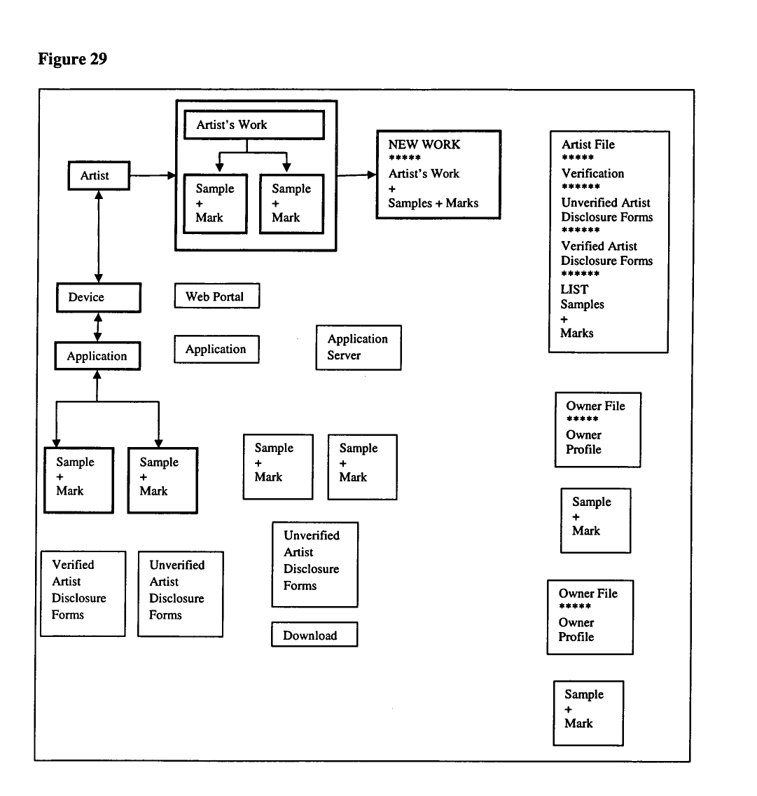

FIG. 30 correlates with step (6), step-subset (1) of the preferred embodiment.

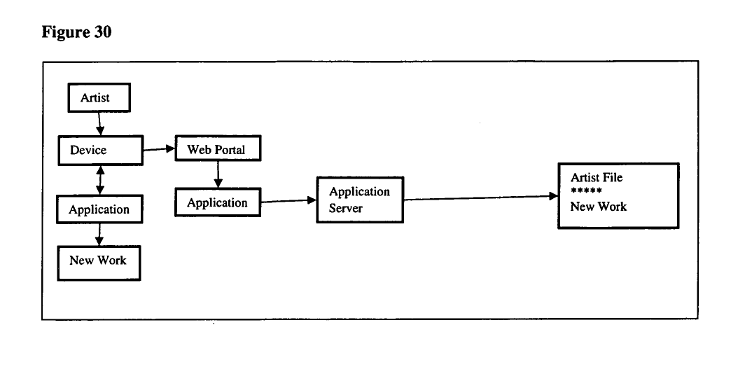

FIG. 31 correlates with step (6), step-subset (2) of the preferred embodiment.

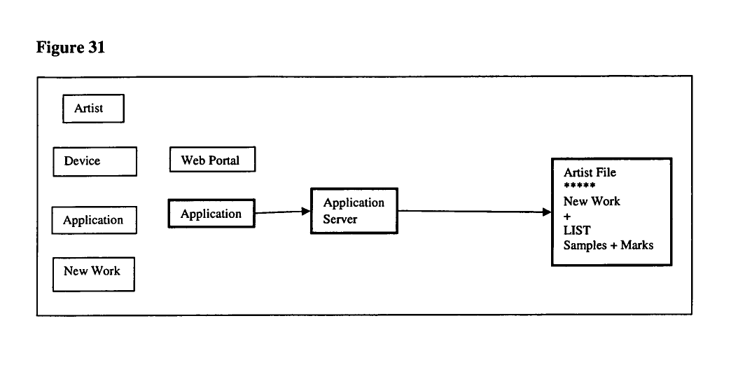

FIG. 32 correlates with step (6), step-subset (3) of the preferred embodiment.

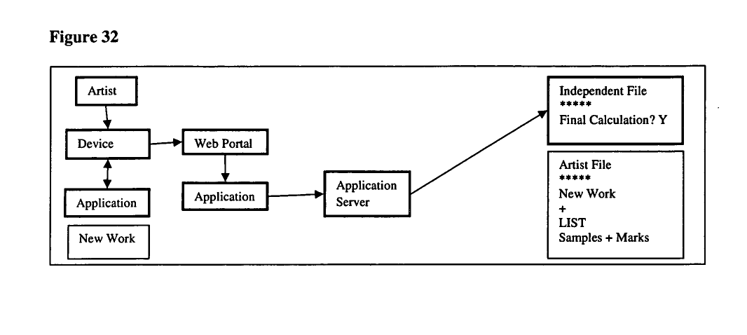

FIG. 33 correlates with step (6), step-subset (4) of the preferred embodiment.

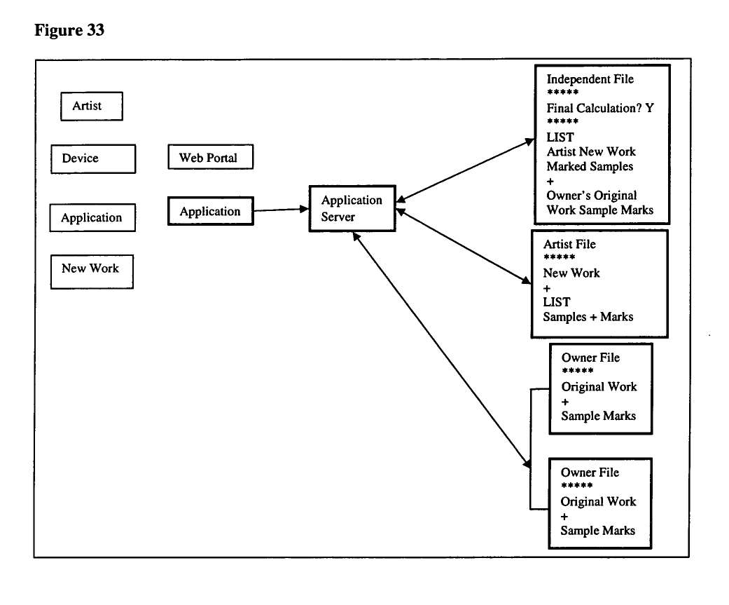

FIG. 34 correlates with step (6), step-subset (5) of the preferred embodiment.

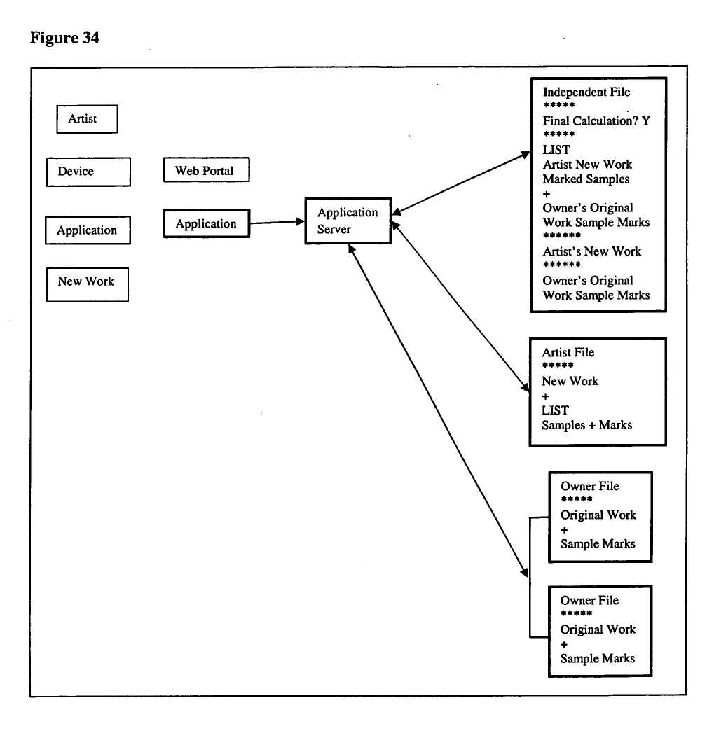

FIG. 35 correlates with step (7), step-subset (1) of the preferred embodiment.

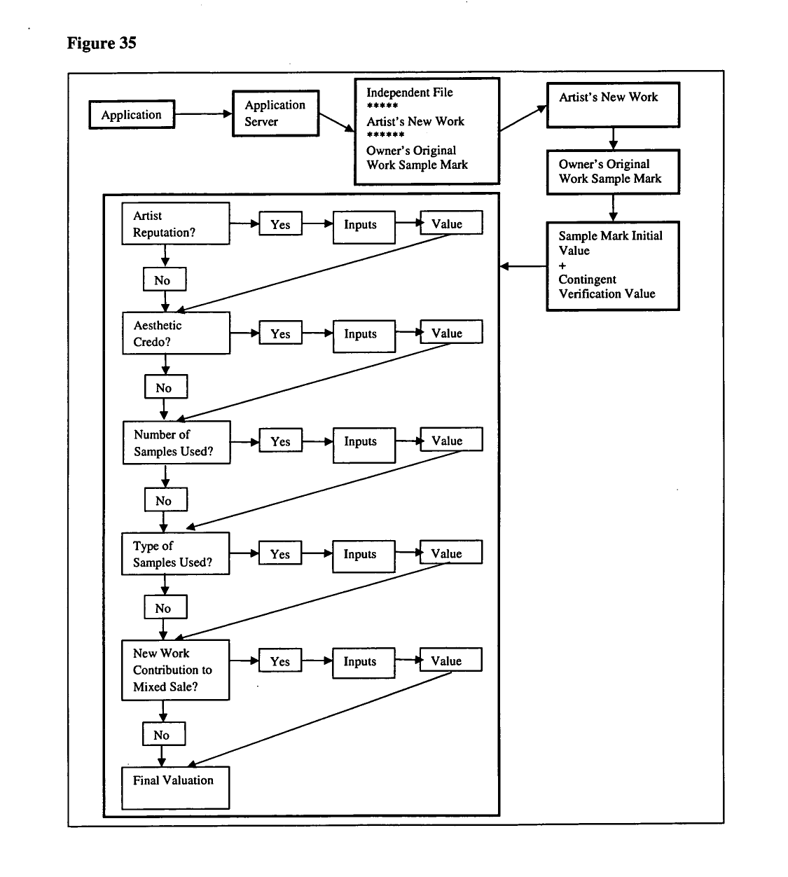

FIG. 36 correlates with step (7), step-subset (2) of the preferred embodiment.

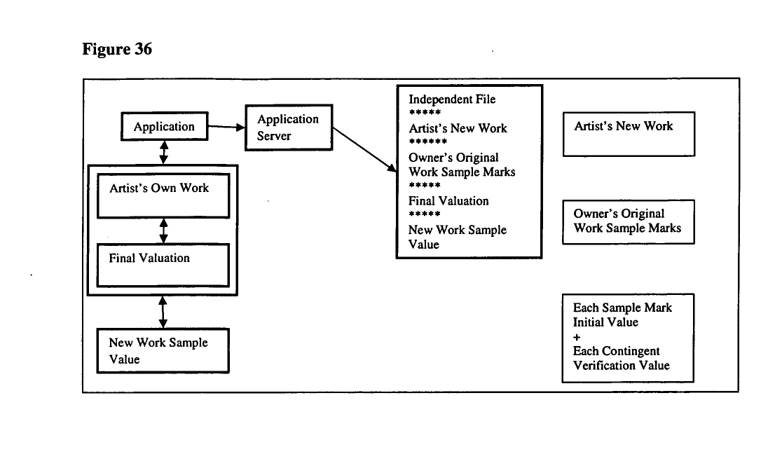

FIG. 37 correlates with step (7), step-subset (3) of the preferred embodiment.

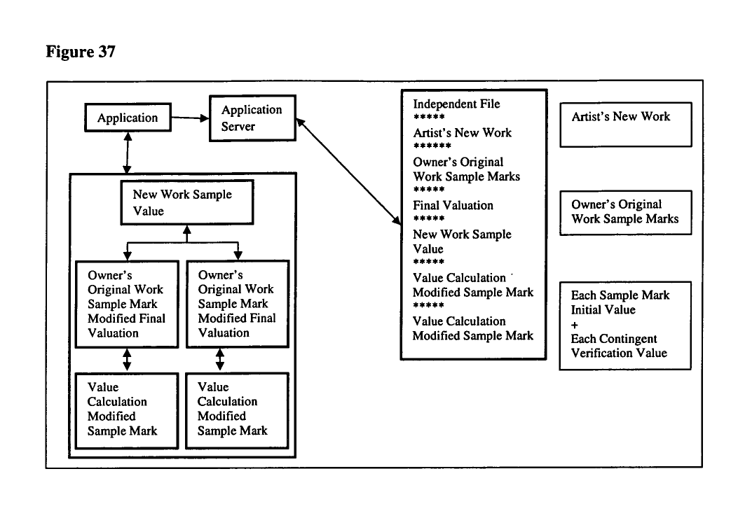

FIG. 38 correlates with step (7), step-subset (4) of the preferred embodiment.

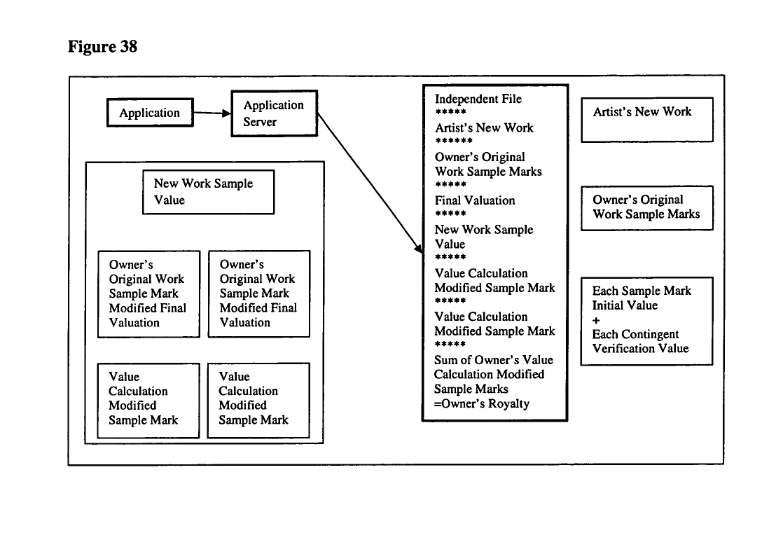

FIG. 39 correlates with step (7), step-subset (5) of the preferred embodiment.

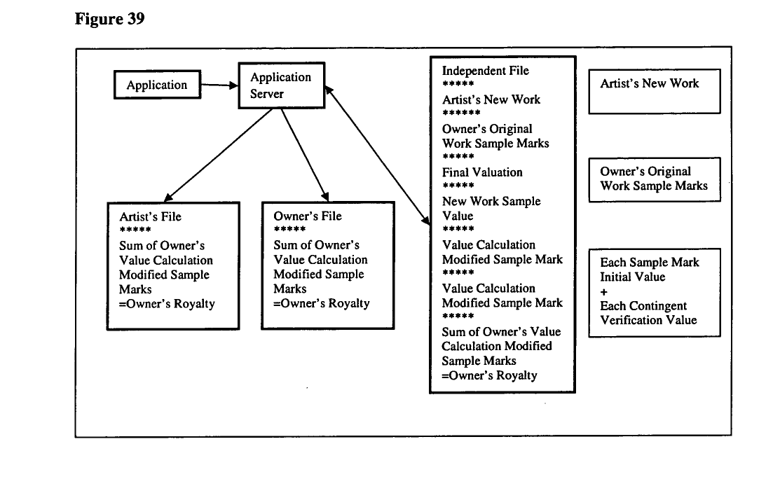

FIG. 40 correlates with step (8), step-subset (4) of the preferred embodiment.

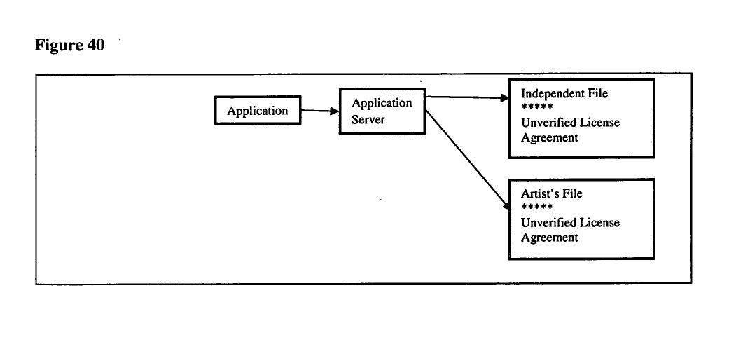

FIG. 41 correlates with step (8), step-subset (1) of the preferred embodiment.

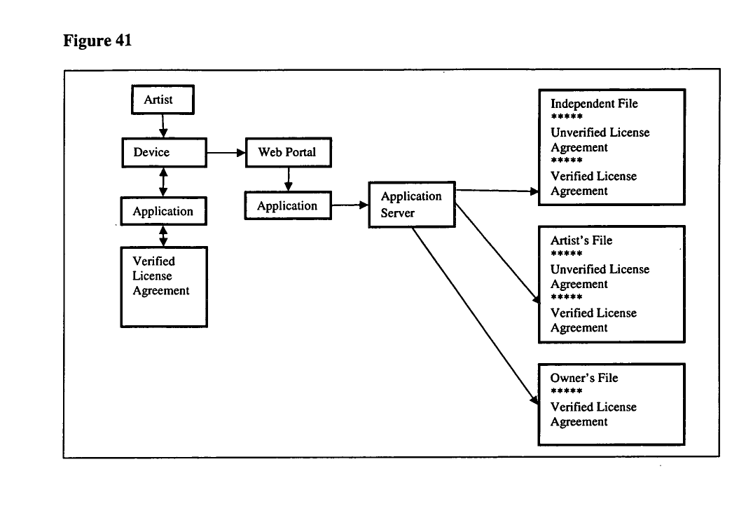

FIG. 42 correlates with step (8), step-subset (2) of the preferred embodiment.

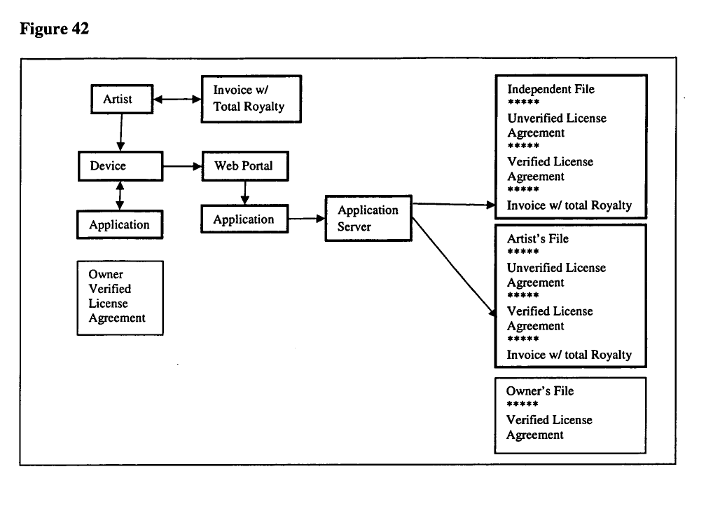

FIG. 43 correlates with step (8), step-subset (3) of the preferred embodiment.

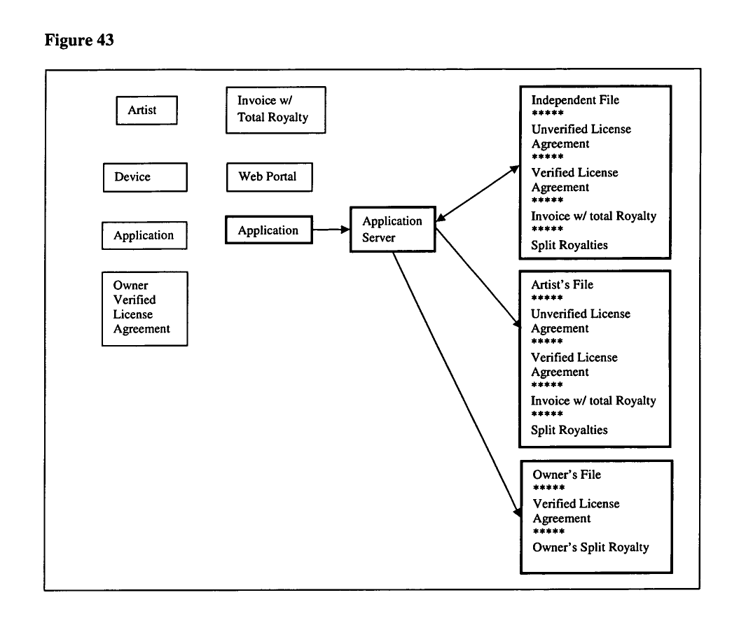

### DETAILED DESCRIPTION OF THE INVENTION

1. Introduction

This description explains in more detail each of the numbered steps found in the brief summary of the invention. These numbered steps proceed in linear fashion.

The following written description of the invention allows a person of ordinary skill to construct and utilize the best current embodiment of the method. This description is the best of several currently conceived methods of executing the invention, and is presented to illustrate the invention's general principles, but should in no way be read to limit the potential scope of the invention or the types of potential embodiments which could stem from the preferred system and method. A person of ordinary skill would appreciate that many variations, combinations, and equivalents of the preferred embodiment exist, and the invention encompasses all systems and methods within the spirit and scope of the claimed invention. Several examples of alternate embodiments within the spirit and scope of the claimed invention are provided after this first description. Again, these alternate embodiments are not designed to be inclusive, but illustrative of the central concept. Please note that several of the steps, especially those pertaining to assigning vales to the various steps, have been presented in summary form for purposes of illustration, but, as alluded to in the description of alternate embodiments, could be developed with far greater sophistication.

2. Definitions

Please note that both the Description of the Preferred Embodiment, the Description of Illustrated Alternate Embodiments, and the Brief Description of the Several Views of the Drawing Sections, use many terms, some of which are defined below, which are identifiable due to their capitalization. Reference should be made to these definitions when appropriate. Note that these defined terms were not used in their “defined” sense in the Background, Technical Field, or Description of the Related Art Sections, because those Sections should be read as a “narrative” and use of defined terms there would have ordinary reading process. Also note that not all of these definitions are used in the Description of the Preferred Embodiment, although all of these definitions were used in either the Description of the Preferred Embodiment or the Description of the Illustrated Alternate Embodiments.

These definitions have been presented in working form. Note that these definitions are often used in the above with different suffixes (e.g., “Sale,” “Sold,” etc. have the same meaning, modified obviously for their semantic import in accordance with suffix addition, as “Sales”). Also note that one or several of the definitions may be subject to certain modifications in accordance with one or several of the alternate embodiments in the Description of the Illustrated Alternate Embodiments section of this Specification. Also note also that all actions performed by the Artist—including, but not limited to, downloading the Application, selecting Marked Samples for download, composing or selling the New Work—could also be performed by the Artist's Representatives. Therefore, use of the term “Artist” naturally incorporates the term “Artist's Representative” in all cases, notwithstanding the fact that both terms have been defined here and are used discreetly in some instances for purposes of illustration.

“Aesthetic Credo”—a discrete set of inputs which an Artist submits along with the Artist's Profile, which disclose information about the Artist, preferably about the Artist's underlying aesthetic, genre, etc., but which may also include a list of the Artist's prior work, sales history, and the like.

“Application”—the computer program, or subsets of the same or linked computer programs, or a series of related programs, which is part of the system and executes some part or all of the methods described herein, whether such execution pertains to all or part of the method of the preferred embodiment, the alternate embodiments, or methods not specifically described which encompass the spirit and scope of the all embodiments.

“Application Server”—a Server linked to the Web Portal by the Application, which performs the commonly understood functions of a Server with respect to data submitted from the User, the Physical Store, and the Online Store through the Application, including the filing and storing of electronic information.

“Artist”—an entity capable of composing New Work. Note that “Artist” also means “Artist's Representative.” An “Artist” can simultaneously be an “Owner” for the same or other purposes.

“Artist Disclosure Forms”—forms generated by the Application, and completed by the Artist, in which the Artist attests that the Marked Samples to be downloaded will be stored by the Artist in a particular manner, and either re-uploaded for purposes of conducting a Final Valuation, or deleted from the Artist's Device within a specified time.

“Artist's Profile”—a discrete set of inputs which an Artist submits to the Application Server in order to gain access to the collection of Marked Samples made available through the Web Portal.

“Artist's Representative”—A human being, or collection of human beings, or a legal entity, or computer software, with which the Artist has contracted with, or interacts with, or which otherwise assists the Artist in all aspects of creating composing and selling the Artist's work, whether that work is New Work or Other Work. One example of an “Artist's Representative” is a recording studio with whom the Artist has signed a contract.

“Content”—the audio media uploaded by the Owner, whether in the form of Samples or Original Works, or any modifications made thereto by the Artist or the Application.

“Device”—any device capable of downloading and/or operating the Application. Preferably, the Device is also linked to an internet-based service although this is not strictly necessary. The Device need not be a physical device, but may exist in a cloud-based environment.

“Final Valuation”—the process, either dynamic or non-dynamic, by which the Application evaluates the New Work relative to the Marked Samples used therein to return the New Work Sample Value.

“Independent File”—a file created by the Application on the Application Server, which contains information including, but not limited to, the Royalty, New Work Sample Value, etc.

“Initial Dynamic Value”—the dynamic value initially assigned by either the Owner or the Application, to each Sample, after using the Application to disaggregate the Samples from the Original Work.

“Initial Fixed Value”—a non-dynamic value initially assigned by either the Owner or the Application to each Sample, after using the Application to disaggregate the Samples from the Original Work.

“Initial Value”—a value, either dynamic or non-dynamic, initially assigned by either the Owner or the Application, to each Sample, after using the Application or another process to disaggregate the Samples from the Original Work.

“Initially Valued Sample”—a Sample which has been assigned an Initial Value.

“License Agreement”—a document generated after the Final Valuation, which contains the New Work Sample Value and the Royalty, which is subsequently agreed to by the Artist and Owner, the latter whose agreement may be made through filing of the document in the Owner's file on the Application Server by the Application, which specifies the terms by which the Royalty will be transmitted through Sales.

“List”—a body of identifying information used for several different unrelated purposes in the system and method of the preferred embodiment, including: generation of the Owner Disclosure Forms, assignment of Marks, etc.

“Mark”—a digital signifier embedded into each Sample which allows that Sample to be located in a New Work, on the Application Server, or elsewhere, provides that Sample's Initial Value, provides a means of verifying whether the Owner has executed a proper Owner Disclosure Form for the Sample, establishes and enforces any limitations placed on viewing by others in accordance with the Owner's Profile, and other purposes.

“Marked Sample”—a Sample which has been Marked.

“Mixed New Work Sample Value”—the process, either dynamic or non-dynamic, by which the Application subjects the New Work Sample Value to a further adjustment, in circumstances where the New Work and Other Work is or may be disposed of by a Mixed Sale, which returns a monetized or monetizable value reflecting an adjustment to the New Work Sample Value in terms of the New Work's contribution to the Mixed Sale.

“Mixed Sale”—the process by which an Artist, or the Artist's Representative, presents both New Work and Other Work in any manner which advances the Artist's interests, whether as an item purchased in a commercial transaction, or as part of an advertising campaign, or as a means of generating interest in the Artist (for example, placing the New Work and Other Work on a website where it can be sampled, or by doing the same while selling the site visitors' personal information to a third party, or by obtaining advertising revenue).

“New Work”—audio media created by the Artist which contains one or several Marked Samples.

“New Work Sample Value”—the value, either monetized or monetizable, assigned to the Samples as they appear in the New Work after the Final Valuation is performed.

“Other Work”—any audio media created by the Artist which does not contain any Marked Samples.

“Original Work”—a discrete, stand-alone audio media recording legally owned by an Owner, whether by way of copyright or otherwise.

“Owner”—the human or legal entity with legal ownership of one or several Original Works. An

“Owner” can simultaneously be an “Artist” for the same or other purposes.

“Owner Disclosure Forms”—forms generated by the Application, and completed by the Owner, in which the Owner attests that the Content to be uploaded is in fact owned by the Owner. This may involve the affixation of copyright symbols. These forms will be capable of autogeneration, and with fields populated from a data source under the control of the Owner.

“Profile”—information submitted by either the Artist or the Owner in response to a series of questions.

“Terms of Service”—a series of terms governing Owners' and Artists' interaction with the web portal and each other, which both Owners and Artists must agree to prior to downloading the Application.

“Royalty”—a monetized or monetizable portion of a Sale remitted by the Artist to the Owner in consideration for use of the Samples, as calculated by the New Work Sample Value. The Royalty may exclude some or all of methods of Sale, or percentages of methods of Sale, employed by the Artist or the Artist's representative, recording studio, or other third party to circulate the Work.

“Sale”—the process by which an Artist, or the Artist's Representative, presents the New Work in any manner which advances the Artist's interests, whether as an item purchased in a commercial transaction, or as part of an advertising campaign, or as a means of generating interest in the Artist (for example, placing the New Work and Other Work on a website where it can be sampled, or by doing the same while selling the site visitors' personal information to a third party, or by obtaining advertising revenue).

“Sample”—any fragment of the Original Work, which includes, but is not limited to: dissociated musical and/or lyrical elements of the Original Work, or a section of all musical and/or lyrical elements of the Original Work, whether or not qualified by a minimum or maximum time interval, among others.

“Server”—a medium for electronic storage and filing of information, whether based on physical or “cloud-based” software, as the same is commonly understood.

“Track”—the process by which Sales of the New Work are traced and placed on an invoice.

“Value Calculation”—the process by which the Marks in the New Work are subjected to a comparison which returns a non-monetized and non-monetizable approximation of their contribution to the total value of the New Work as a function of any subsequent Royalties.

“Verification”—the process by which the Application compares an Owner's Profile preferences against the Aesthetic Credo of the Artist to determine whether the Artist will be permitted to view and/or download all or some of that Owner's Marked Samples.

“Web Portal”—an internet-accessible website linked to the Application Server, accessible to the Artist and Owner, or either of them, which serves as a medium for those parties to interface with the Application Server and download and upload certain information. Alternatively, the Web Portal may exist entirely offline and be connected to through hard-wired ports.

3. Description of the Preferred Embodiment

The preferred embodiment is separated into the numbered “steps” contained in the Brief Summary of the Invention section of this Specification. Though mentioned previously, please note that this preferred embodiment is only one illustration of the system and method; those practiced in the art will appreciate that many other alternate systems and methods are possible.

(1) The individual components of copyright-protected works are disaggregated into “samples” and uploaded to an internet-accessible web portal.
1. Owners individually connect to the Web Portal through the internet onto their Device.
2. Connected Owners download the Application from the Web Portal, sign the Terms of Service, and then complete the Owner's Profile.
3. The Application creates an Owner file on the Application Server and saves the Owner's Profile and the Terms of Service to the Owner file.
4. Owners use the Application to upload the Original Work to the Application Server, after providing certain identifying information for each Original Work. The Application saves the Original Work in a sub-folder in the Owner's file, and saves the identifying information in a List on the Owner's file.
5. Owners use the Application to disaggregate the Samples of the Original Work. The Application saves each Sample in a sub-folder attached to the sub-folder containing the Original Work from which that Sample was derived.

(2) The copyright-holder assigns a value to each “sample.”

Note that there are many possible inputs, or combinations of inputs, by which an Initial Dynamic Value or Initial Fixed Value can be derived. All Initial Values may be made subject to the Royalty. The inputs to the Value may be rendered useful by, for example, using them to derive a “score” of 0.00 to 100.00 of a possible maximum range of a total value percentage. The Initial Value is not a final value, but a relational percentage. For example, it could be possible for one particularly valuable Sample to have 100.00 of the Initial Value, or for two Samples to “divide” the Initial Value 50.00/50.00 or 70.00/30.00. The following illustrations of Initial Value inputs are only descriptive, not comprehensive.
1. Owners use the Application to bring up each Sample from the appropriate place in the Owner file.
2. The Owner then assigns a contingent Verification value, which may include, but is not limited to:
   a. Add contingent Verification value
      i. Aesthetic Credo—fixed (must satisfy Verification)
      ii. Aesthetic Credo—sliding (higher fixed cost if unsatisfactory Verification)
      iii. Aesthetic Credo—sliding (higher sliding cost if partially unsatisfactory Verification)
      iv. Other
   b. Do not add contingent Verification value
3. The owner then assigns an Initial Value, which may include, but is not limited to:
   I. Initial Fixed Value
      a. Time indexed
      b. Component indexed
         i. Individual instruments/sounds
         ii. Vocals
         iii. Other
      c. Other index (“signature” moments)
   II. Initial Dynamic Value
      a. Initial Fixed Values (from above)
      b. Commercial success
         i. By commercial success of the Original Work
         ii. By commercial success of Original Works containing a number of similar Samples
      c. Adjustments
         i. By number of individual downloads
         ii. By number of individual Value Calculations
         iii. By amount of New Works
         iv. By amount of Sales
         v. By amount of Royalties
      d. Relation to other Samples in the Original Work
         i. Fixed
         ii. By number of individual downloads
         iii. By number of individual
      e. Relation to other components of other Original Works
         i. Original Works owned by particular Owner
         ii. Original Works owned by other Owners
         1. Other Owner Original Works—similar to Owner Original Works
         2. Other Owner Original Works—not similar to Owner Original Works
      f. Relation to Artist
         i. By number of prior downloads
         ii. By number of prior Sales (Sales, Mixed Sales, or both)
         iii. By type of prior Sales
      g. Other relation
   III. Other Values
4. The Application saves the Contingent verification value and the Initial Value in the Sample sub-folder of the Original Work sub-folder of the Owner file on the Application Server.

(3) The valued “samples” are made available to artists after the owner signs certain forms.
1. The Application scans the List in the Owner file, generates the Owner Disclosure Forms based on the list of names of Original Works, and saves an unverified Owner Disclosure Form in an Owner sub-file designated with information from the List.
2. The Application sends a copy of the unverified Owner Disclosure Form to the Owner's Device.
3. The Owner completes and uploads the verified Owner Disclosure Forms to the

Application Server through the Web Portal. These forms are saved to the Owner file on the Application Server in the corresponding sub-file.
4. The Application compares the verified Owner Disclosure Form against the unverified Owner Disclosure Form for any ambiguities.
5. If there are ambiguities, the Application sends a notification to the Owner's Device and saves a copy of the ambiguities to the Owner file.
6. If there are no ambiguities, the Application then saves a copy of the finalized Owner

Disclosure Form, and then Marks all Samples from each Original Work, and also Marks the Original Work with all of the Marks from the Samples derived from that Original Work.
7. The Application makes the Samples viewable to others through the Web Portal.

(4) Artists, accessing the web portal, can browse the various “samples,” listen to them, and then select them for download.
1. Artists—Registration Requirements
   a. Artists individually connect to the Web Portal through the internet onto their Device.
   b. Connected Artists download the Application from the Web Portal after signing the Terms of Service and setting up a Profile, which includes information about the Aesthetic Credo of the Artist.
   c. The Application creates an Artist file on the Application Server.
   d. The Application performs the Verification by comparing information in each Owner's Profile against the Artist's Aesthetic Credo.
   e. After satisfying Verification for any Marked Samples, the Application saves the Verification in the Artist's file and makes the Verified Marked Samples viewable to the Artist through the Web Portal.

2. Browsing
a. The Artist browses the Marked Samples located on the web portal.
b. The Artist may listen to the Marked Samples prior to download.

(5) The artist downloads the “samples” and uses them in his or her new musical composition.
1. Artists select Marked Samples for download to the Artist's Device.
2. The Application scans the selections, generates unverified Artist Disclosure Forms based on the Marked names of Original Works associated with each Marked Sample. In the Artist Disclosure Form, the Artist agrees that all downloaded Marked Samples will be stored by the Artist in a particular manner, and either re-uploaded for purposes of conducting a Final Valuation, or deleted from the Artist's Device within a specified time. These forms are saved to the Artist's file on the Application Server and sent to the Artist's Device.
3. The Artist signs the unverified Artist Disclosure Forms, which are then saved on the Artist File on the Application Server.
4. The Application saves a list of each downloaded Marked Sample to the Artist's file on the Application Server. The list is generated from the names on the Artist Disclosure Forms.
5. The Application downloads the Marked Samples selected by the Artist to the Artist's Device, based on the list generated by the names on the Artist Disclosure Forms.
6. The Artist uses the Marked Samples in artist's own work to create the New Work.

(6) The artist uploads a copy the new musical composition to the server, the application performs a search of artist's new musical composition, and searches for signatures attached to each “sample.”
1. The Artist loads the New Work in his or her Device, then uses the Application to upload the New Work to the Artist's file.
2. The Application performs a search of the New Work for Marked Samples, and saves a copy of these in the Artist's file.
3. The Artist indicates that they are “ready” to begin the Final Calculation, and the Application saves the acknowledgment in an Independent File on the Application Server.
4. The Application compares the list of Marked Samples in the Artist's file against those in the Owners' files and places the list in the Independent File.
5. The Application saves both the Marked Samples from the list, and the New Work from the Artist's File, in the Independent File.

(7) the application returns a value to the artist, both in terms of the value of all “samples” used in the new musical composition, and as discrete royalty payments owed to each copyright-holder.
1. The Application compares the Initial Values and Contingent Verification Values of each Marked Sample of each Owner in the New Work, one at a time, to arrive at the Final Valuation. The Final Valuation may take into account, but is not limited to:
   a. Artist reputation
   b. Aesthetic Credo
   c. Number of Samples used
   d. Type of Samples used
   e. Total time of Samples used
      i. Fixed time
      ii. As percentage of total New Work time
      iii. As percentage of discrete audio elements in New Work
   f. Contribution of New Work to Mixed Sale
2. The Application generates the New Work Sample Value by comparing the Final Valuation to the New Work, weighing the ratio of the Final Valuation to the Artist's own work, and saves both the Final Valuation and the New Work Sample Value in the Independent File.
3. The Application retrieves the Owner's Original Marks, as modified by individual Final Valuations, and performs a Value Calculation by comparing each Marked Sample against the New Work Sample Value, to return a percentage of the New Work Sample Value attributable to each Original Mark. The Application saves the modified Sample Marks in the Independent File.
4. The Application adds the New Work Sample Value the number of Marked Samples attributable to each Owner, and saves it in the Independent File. This is the Owner's Royalty.
5. The Application saves the Royalty to the Artist file and all applicable Owner files.

(8) Should the Artist choose to proceed in selling the new musical composition, the Artist signs a license agreement, agreed to by the copyright-holder by reference, which requires submission of some form of invoices to the copyright-holder reflecting the number of sales of the copies of the song which are sold, which reflect the royalty payment.
1. The Application generates the unverified License Agreement and stores a copy in the Independent File and the Artist's File.
2. The Artist downloads and signs the License Agreement, signs it, and then uses the Application to send it through the web portal through the Application Server to the Independent File, the Artist File, and all applicable Owner files. For purposes of owner agreement to the Verified License Agreement, saving the document in the Owner's file is deemed sufficient.
3. Artist submits invoices which reflect the total Royalty payments to web portal, and copies of invoices saved to the Artist and the Independent File.
4. The Application splits the total Royalty on the Artist's invoice from the Independent File among the Owners whose Value Calculation Modified Sample Marks appear on the Invoice with the total Royalty, and then saves a copy of each Owner's Royalty amount in the Artist's file, the Independent File, and all Owners' files. Payment of the split Royalty amounts is arranged between the Artist and all Owners, perhaps by an automated method linked to the Invention or by another method.

4. Description of the Illustrated Alternate Embodiments

The alternate embodiments listed below are designed as illustrative, not comprehensive, and those practiced in the art will appreciate that a range of other alternate possibilities could be developed in addition to those alternate embodiments listed here. For the sake of ease, these illustrations have been roughly correlated with steps (1) through step (8) above to the extent that each illustrated alternative embodiment reflects a change in that particular step. Note that the numbered paragraphs do not correspond with the numbering within each of the steps listed above in the Description of the Preferred Embodiment.

(1) The individual components of copyright-protected works are disaggregated into “samples” and uploaded to an internet-accessible web portal.
1. The preferred embodiment involves a stand-alone web portal and application to which

Samples of songs are uploaded. In this manner, an artist enjoys the widest possible selection for their New Works. However, Owners, especially holders of many protected works, may not wish to place these Samples on a third-party platform, even if the Samples are protected by Marking, Profile restrictions, and otherwise. Additionally, Owners may also object to having their Content compared with, and valued against, the Content of competitors, especially if similarities in Content result in overlapping or compromised Valuations. Therefore, an alternate embodiment of the Application could allow for individualized download of the viewable platform to a web portal hosted by the Owner, which would display only Marked Samples of its own Original Works, or even an Artist physically entering a space where he or she could connect with an Owner-controlled Server through a hard-wire connection to download Marked Samples. Either of these two alternate embodiments, arguably the simplest renditions of the invention, would incur significantly reduced costs in programming, valuation, invoicing, and the like, as all activity would be generated between a single Artist and a single Owner. Many of the steps outlined above in the preferred embodiment would also become irrelevant if either of these alternate embodiments were undertaken.
2. Alternatively, the Web Portal could be modified to bar an Artist from downloading Marked Samples from more than one Owner, or rejecting all Final Valuations subsequently submitted by the Artist which contained Marked Samples from more than one Owner, or allowing each Owner to selectively “screen” all Content from one Owner, or return only a certain type of Samples from a number of Owners. This last step can be performed whether or not Samples are downloaded from the Web Portal, or a portal controlled entirely by the Owner. Such “screening” could also be performed via notifications or warning “boxes” appearing during the course of the Artist's browsing of Samples, which warn the Artist that certain Samples might not be capable of combination in a New Work if that New Work is to achieve a Final Valuation, New Work Sample Value, and Royalty.
3. The preferred embodiment permits disaggregation of the Samples from the Original

Work after the Original Work is uploaded to the Owner file, as this will likely be simpler for purposes of programming the Application. However, it is possible that the Owners already have the Original Work in disaggregated form readable by the Application. If this is the case then the Samples can be uploaded as-is after being “read” by the Application. Another alternate embodiment could allow for disaggregation to occur offline and prior to Owner upload of any or some of the currently required information.
4. During the time in which the Owner sets up a Profile on the Web Portal, the Application will prompt the Owner to answer basic questions about the Owner's business, most importantly whether the Owner is in fact an Owner, or an Artist, or both. Obviously the Profile information is dynamic and may be updated by the Owner periodically, and only some of the total Profile information need be completed prior to upload (i.e., information needed to complete Sample valuations and complete License Agreements). In a case where the Owner wishes to provide its Marked Samples to the Artist free of charge, less information than this might be provided, although in this case specific marking of the Samples as “free” would be required in order not to corrupt any subsequent valuations of the New Work. Providing profile information could be further automated by allowing the Application to search the internet or some other resource to autogenerate Owner data. Other embodiments could permit flexible modification of Owner Disclosure Forms.
5. In connection with the Terms of Service, “sign” is shorthand for “agree,” which in the digital arena is typically performed by checking a box on an autogenerated document.

However, because a stipulation to the Terms of Service will be that the Owner agrees to, inter alia, not modify the Owner Disclosure Forms, a more “traditional” method of agreement—such as requiring a digital signature, or even printing and submitted a document containing a hand-written signature—are also possible in other embodiments. Conversely, alternate embodiments could shift the “signing” of the Terms and Service to after establishing an Owner Profile but before uploading any Content.
6. In the preferred embodiment, the Owner downloads the Application from the Web Portal to at least one Device. In alternate embodiments, however, the Application would exist solely on the Web Portal, and the Owners could simply “log in” from any Device capable of connecting to the Web Portal and use the Web Portal's “version” of the Application. In this embodiment, an Owner would be required to provide some rudimentary information, establishing a basic “Profile,” which included establishing a username and password. This embodiment, while simpler, comes with the greater risk that the Owner's profile information will be pirated, allowing third parties access to the Owner's Content.

(2) The copyright-holder assigns a value to each “sample.”
1. For sake of simplicity, the Original Work could be listed as 100% of the Initial Value, and the various Samples could be listed as percentages of the Initial Value. This does not take into account that the value of the whole is substantially higher than the sum of its parts, however; thus, the Initial Value could be subjected to a secondary calculation which “downgrades” the percentage of each Sample's Initial Value as a percentage of the value of the Original Work. Initially the Owner sets all percentage; if the preferred embodiment of placing all data on a single server is used, then prices will gradually shift to reflect a competitive marketplace. Such market protections do not exist, however, in alternate embodiments where the Owner presents only that Owner's data for download.
2. The preferred embodiment allows the Owner to manually assign Initial Values to each Sample, as each Owner will likely experiment with different Initial Values of the Samples of the Original Works. However, for the sake of administrative ease these functions could be automated, with the Application assigning an Initial Dynamic Value based on which Attributes are contained in each Sample, or by a simple fixed value. Additionally, the value could be made Artist-specific—i.e., the Artist would have permission to use a certain maximum number of Samples in the New Work, or use a certain maximum number within a specified period. As noted in the preferred embodiment, there are innumerable different means by which the Initial Dynamic Value or Initial Fixed Value could be determined, and many of these valuations could significantly reduce the amount of time the Owner spends in determining how much each Sample is “worth.”
3. The preferred embodiment allows the Owner to produce the Initial Values online while using the Application. However, in order to prevent potentially fraudulent uploads, alternate embodiments could permit the Owner to use the Application to initially value the Samples offline, and upload the Marked Samples to Application Server only after the Owner has attested to their ownership by signing the Owner Disclosure Forms.
4. The preferred embodiment allows an owner to limit the types of Artists who can make use of the Sample, by means of comparing the Owner Profile against the Artist's Aesthetic Credo. It also envisions that “valuation” of any Marked Sample could be along a sliding scale, with higher values for Artists whose Aesthetic Credo somehow failed Verification. This would allow an Artist use of a broader range of Marked Samples, provided they are willing to pay a premium. The Verification Values are not part of the “value” of the Sample, but a contingent value which permits a particular Artist to either access or not access the Sample. The exception here is the “sliding” Verification values, which could be presented to the Artist in a number of different ways, probably as an “addition” to the Initial Valuation. However, alternate embodiments could prevent any such “sliding scale” valuation of a Sample.

(3) The valued “samples” are made available to artists after the owner signs certain forms.

1. It is likely that when the Original Works are disaggregated into Samples, a list of names of these Original Works could be autogenerated for later use in both completion of the Owner Disclosure Forms and the Application's “check” of the Forms against the list. The “check” is necessary to ensure that the Owner Disclosure Forms are not modified between the time of their completion and the time of their upload. At the time of the upload of these forms, the Application will also perform a semantic check of other parts of each Owner Disclosure Form to besides the name of the Original Work, to ensure that the content of the document has not been compromised. It is also possible that, if the Application somehow fails to detect a change in the Owner Disclosure Forms which results in material change and material harm to any party, sanctions could be imposed against the Owner. An agreement not to alter the Owner Disclosure Forms could likely be made part of “terms and conditions” which an Owner agrees to at the time of downloading the Application.
2. It is also possible that, because the preferred embodiment saves an autogenerated and unverified Owner Disclosure Form in the corresponding Owner sub-file, the Application could “check” the integrity of the completed Owner Disclosure Form against the unverified Owner Disclosure Form already saved in the Owner sub-file, and prohibit upload of any files if ambiguities between the completed and unverified forms.
3. Marking each Sample, and cross-referencing against the Original Work, will allow the Owners to more easily adjust the value of each Marked Sample. For example, if a sophisticated Original Work which contains many Samples becomes commercially successful, and an Initial Dynamic Value has been assigned, the Owner may wish to increase the overall cost of all Marked Samples from that Original Work. Additionally, Original Works could be cross-referenced for purposes of other Initial Dynamic Values, so if the Owner believes that he or she has generally “undersold” the market and wishes to make a great number of Samples more “expensive,” the Owner could adjust the values without performing a great number of computations.
4. Despite the administrative ease of this system, Owners may be uncomfortable with uploading a copy the Original Work to the Application Server, or do not wish to establish any relationship between the Samples and the Original Work; therefore, so alternate embodiments would not transfer the Marks from each Sample back to the Original Work, either because the Original Work was not uploaded, or for other reasons. In alternate embodiments, the “global” adjustment to values would not depend on cross-referencing to the Original Work.

(4) Artists, accessing the web portal, can browse the various “samples,” listen to them, and then select them for download.
1. It is envisioned that Verification will be an automatic process—i.e., the Application will scan each Owner Profile for any pre-set preferences. Non-automated process could prove unwieldy, especially if there are a great number of Artists seeking access to Marked Samples, and a great number of Owners who have posted them. However, alternate embodiments could provide for manual or semi-manual Verification. Other alternate embodiments could perform a second Verification at the time the Artist seeks to download the Marked Samples, or at some point after the Artist uploads his or her New Work. These second Verifications could also be automated, semi-manual, or manual.
2. It is envisioned that after evaluation of the Artist's Aesthetic Credo, the Application will perform periodic Verifications, i.e., re-evaluating the Aesthetic Credo against the Owner Profiles to ensure that the list of viewable Samples is accurate. However, in between these periodic Verifications, the Application will simply retrieve the Verification from the Artist's file and return any Marked Samples which had been Verified. This will cut out unnecessary programming steps which would require the Application to perform near-continuous Verifications and likely result in considerable losses in efficiency and which may “slow” the loading speed of the Web Portal. However, alternate embodiments could adjust for this feature.
3. It is envisioned that the Initial Value, at the time of browsing (or perhaps download), will provide an approximate “range” of potential values in order to assist the Artist in selecting Marked Samples. This step is not immediately necessary, and may become problematic if the Owner's control over the valuation is made dynamic and subject to repeated change, although it prevents the Artist from wasting time. Alternate embodiments would not present that “range.” In this case, the Artist would likely learn from experience what types of Marked Samples would like result in overly costly Royalties from New Works.
4. During setting up a “profile,” the Artist will answer basic questions about his or her operation, most importantly whether the Artist is also an Owner. The Artist may be asked questions about his or her artistic style, influences, etc., in connection with the Aesthetic Credo. In the preferred embodiment the Aesthetic Credo is completed at the time the Artist completes the Profile, after the Artist has identified him or herself as an Artist. This will ensure that in the course of the browsing, the Artist is aware of the potential limitations on the Samples he or she is permitted to download. In alternate embodiments, the Aesthetic Credo is a severable step, completed at some point after Profile completion but before download. In still other embodiments, the Aesthetic Credo is completed only before a Final Valuation is performed. These alternate embodiments save time during the Profile process, although they risk resulting in considerable amounts of wasted time once an Artist's preferences for Sample use are barred.
5. Although the preferred embodiment gives the Artist access to all of the uploaded Samples upon Profile completion, alternate embodiments would submit the Artist's information, as well as a potential sample of their work, to any Owner who requested verification. This “screening” could be automated, or performed manually, or both. “Screening” at this level would ensure that no Artist experiments with Marked Samples which would ultimately be rejected by Owners as part of a New Work due to an Owner's concern regarding an Artist's particular aesthetic import. Notably, a second “screening” would have to be performed at the time the New Work Sample Value is returned, to further ensure that the Artist had not somehow included a copy of “screened out” Samples in the New Work.
6. In alternate embodiments, in order to keep Artists from feeling as if their privacy is being unduly invaded, the Artist would not need to fill out an Aesthetic Credo as part of the Profile, but would instead be permitted to immediately browse and download all Samples which Owners do not signaled for Verification.
7. The preferred embodiment does not Track the Artist's browsing and listening history, in order to preserve Artist privacy. However, other embodiments could reflect some or all of this browsing history, and perhaps incorporate it into either the New Work Sample Value, or the Initial Values of Samples which have been assigned an Initial Dynamic Value. Still other embodiments could Track the Marked Samples after they are downloaded by the Artist. Any of these embodiments could allow access to Tracking data by the system and method administrators, the Owners, or both.
8. As indicated in the definitions, an “Artist's Representative” is capable of taking any action which an “Artist” could take. In an alternate embodiment, any Artist's Representative with whom the Artist later is affiliated—such as a record label—could also register with the Web Portal, and could have the registration features of an Artist, and Owner, or both. Still another embodiment could provide a separate “Artist's Representative” set of registration requirements. Still another embodiment could, in a situation where the Artist has already “signed” with the record label at the time of composition, allow the record label to register in the same manner as the Artist, and all Marked Sample downloads and New Work uploads are saved to the Record Label's file in a sub-folder created for the Artist. Other embodiments, reflecting a different legal relationship between the Artist and the Record Label, are also possible.

(5) The artist downloads the “samples” and uses them in his or her new musical composition.
1. In order to protect the Owner's Content, it could be the case that the Application Server contains a usable music-creation software platform, which Artists can use to create their Works. In this case, the Artist would upload his or her own original music files to the Application Server, where they would be stored in the Artist file. The Artist could then combine his or her own work with the Owner's Content. With the exception of keeping all Content entirely off-site, this embodiment achieves maximum protection and control of Owner content, because no Content is downloaded from the Application Server to the Artist's own equipment. However, it is anticipated that being compelled to use a specific program to create their New Works would be completely unsatisfactory to many Artists.
2. Alternatively, the Artist could purchase a license allowing a certain specified number of Marked Sample “downloads” (either subject or not subject to Verification prior to use to ensure that the copyright is not unduly infringed). This alternate embodiment involves greater risk to the Artist, who must incur up-front costs for a work which ultimately may be rejected. It could be possible for the copyright-owner to reimburse the artist in the event of a rejection, or to “guarantee” that Verification would ultimately be permitted for all or a range of the Artist's New Work. Alternatively, the Artist could pay the New Work Sample Value at the time he or she uploads the New Work, instead of paying Royalties at a later date. Again, this presents the artist with up-front costs, although it could also liberate the artist from having to submit invoices.
3. As previously noted, step (4) is the time at which “screening” of the Artist takes place, through the Owner's evaluation of the Artist's Aesthetic Credo. However, another embodiment would perform “screening” at the point at which an Artist downloads the selected Samples. Performing the “screening” at this stage is more precise, but less efficient in that the Artist would expend considerable time in selecting potential Samples prior to download, only to be told that the New Work could not be subjected to a Final Valuation leading to a New Work Sample Value and a list of Royalties. Still other embodiments could perform “screening” at the time a New Work is subjected to a Final Valuation. This alternate embodiment carries the same risks as above.
4. The Artist Disclosure Forms are included in this step in the preferred embodiment because of the possibility that individual Owners will wish to provide additional terms beyond the generic terms to be reflected in their agreements. This preference, which might be confusing to the Artist, is nevertheless inherent in the idea that an Owner is relinquishing intellectual property rights. In the preferred embodiment notification is not given to the Artist of any additional terms (although the Artist Terms of Service will include language which states that the terms may differ). In alternate embodiments, it is possible that the Artist Disclosure Forms could contain only transmittal information formalizing agreements previously agreed to in the Terms of Service (e.g., restrictions on use, time before deletion, etc.). Moreover, the presence of Disclosure Form terms “outside” the normal terms could be revealed to the Artist prior to download through a simple procedure in which the Application compares the language of a “template” Disclosure Form stored in an Independent File against the language of the particular Artist Disclosure Form (excluding form-filled boxes such as the Original Work name), notes differences, and sends a cautionary message to the Artist which indicates both the presence of differences and what the differences exist.
5. Issues may develop due to the time difference between artist browsing, download, and Owner changes to the Initial Dynamic Values of particular Marked Samples. Namely, an Artist who has “priced” a certain number of Marked Samples may find that intervening adjustments to any, some, or all Marked Sample Initial Values has made the New Work far more “expensive” than previously expected. In the preferred embodiment, the saved history of downloads works retroactively, “fixing” the value of the Marked Sample at the time of Artist download. While this preference may result in slightly compromised revenue expectations for Owners, Owners can control this fluctuation by establishing up-front limitations for how long an Artist has between download of a Marked Sample and submission of a New Work to the Final Valuation. In other embodiments, the value of the Marked Sample to which any Initial Dynamic Value has been assigned would remain subject to adjustment until the time of the Final Valuation. This alternate embodiment could account for any “gap” which results from the Artist having uploaded the New Work to the Application Server to avoid violating pre-set durational limitations on the Artist's use of the Sample, as described below in the alternate embodiments to step (6).
6. Similarly to what was noted in the last paragraph of the alternate embodiments classified under step (4), the preferred embodiment does not provide notification to the Owner that the Artist has downloaded any of their Marked Samples, in order to protect the creative process of the Artist from infringement and further Artist privacy, as it is presumed that protection of Owner Content can be ensured by other means, such as through the signing of Artist Disclosure Forms, etc. In other embodiments, however, Owners could receive notification when Artists were downloading their Marked Samples, or when a New Work was submitted for a Final Valuation, etc.

(6) The artist uploads a copy the new musical composition to the server, the application performs a search of artist's new musical composition, and searches for signatures attached to each “sample.”
1. It is possible that only the Artist file, and the lists saved thereto, will be used for purposes of the search for Marks, if privacy of “invading” the Owner's file is an issue. The Owner will not be able to view the New Work or the search for Marks until the Artist agrees to perform the Final Valuation. As noted above, this protects the Artist's creative process from “poaching.” However, in other embodiments where privacy is less valued or the Artist is working with prior owners in a more collaborative environment, the restriction against Owner viewing of the New Work prior to performance of the Valuation could be relaxed.
2. The Final Valuation is not performed automatically upon upload, because the Artist may simply wish to wait until he or she has composed many different New Works before finalizing Royalty amounts, etc. Moreover, if there is a time limit for use of a particular Marked Sample, and the Artist intends to use it but is mired in the creative process and is running out of time to upload the New Work containing that Marked Sample, it may be easier to simply upload the New Work and let it “sit” on the Application Server until the Artist is ready to perform the Final Valuation. In this case, the Artist would be unable to download the New Work once the time had expired without first requesting an extension of the “termination” time for one or several Samples, or else performing the Final Valuation.
3. In the preferred embodiment, Artist files are automatically deleted from the Application Server once steps are completed, if the Artist elects that course of action. For reasons connected with time-sensitive deletion of Marked Samples from the Artist's Device within a certain period of time, and the need for the Artist to upload the New Work to the Application Server in order to avoid violating the Terms of Service, automatic deletion does not take place in the preferred embodiment. However, in other embodiments where space is a concern, the New Work could be automatically deleted after a period of time.

(7) the application returns a value to the artist, both in terms of the value of all “samples” used in the new musical composition, and as discrete royalty payments owed to each copyright-holder.
1. The list of inputs in generating the New Work Sample Value in the preferred embodiment extremely general and non-exclusive, and is used for illustration purposes only. Many more sophisticated inputs could be factored in. Similarly, the list of inputs in generating the Royalty in the preferred embodiment extremely general and non-exclusive, and is used for illustration purposes only. Many more sophisticated inputs could be factored in. In alternate embodiments, an Owner could specify that its Samples are not to be combined with those of any other Owner, or a particular set of Owners, or a particular subset of types of other Owner Samples, and the like. The initial “screening” of these variables would not take place here, but at the time the Artist downloads the Samples.
2. Similarly, although the preferred embodiment presents a Royalty calculation and the steps by which it is undertaken, there are numerous alternate ways of dividing the various values to arrive at the Royalty payment. For example, one could divide the Artist's New Work against all Marked Samples to arrive at the New Work Sample Value, and then perform all calculations for the Marked Samples before dividing the Royalty payments among Owners. One could also “extract” the total value of the Artist's own work from the “value” of all Marked Samples attributable to each owner without any disambiguation for each of that Owner's Marked Samples. Alternate embodiments adjust for these and other differences.
3. The reason why both “New Work Sample Value” and “Royalty” are used is that the former refers to the total value of all Marked Samples used, whereas the latter refers to each discrete portion of the New Work Sample Value attributable to each Owner. However, in an alternate embodiment, a single Royalty payment could be submitted by the Artist to the Application Server, and the Application would divide the Royalty among the various Owners. This step allows greater administrative ease, but does not necessarily assist the Artist in determining which Samples were particularly expensive, unless a second Royalty is generated for the Artist which demarcates these values. Alternate embodiments could adjust for these tensions.
4. It is presumed in the preferred embodiment that the Application will not accept all “fragments” from a particular Owner, such as a general time-signature. It is presumed that even if accepted, such “fragments” would have a “value” of 0 and therefore although factored into the Royalty payment, they would return no monetized value. Even to the extent that such “fragments” did have any “value,” they would likely be duplicated en masse by Owners and virtually no “value” will be returned to the Owner in any case. Alternate embodiments could account for all values, whether “fragmented” or otherwise; still other embodiments could ensure that such “fragments” are never capable of initial disambiguation and calculation.
5. In the preferred embodiment the Royalty is not assigned a “hard” value, but only a relational percentage of whatever final sale price the Artist chooses to affix to the New Work. This allows flexibility in the types of Sales which the Artist can engage in. In other embodiments, the Artist would enter fixed values at which the New Work will be Sold, and therefore return a “fixed” dollar amount of Royalty. This alternate embodiment decreases flexibility, but also ensures certainty. In other embodiments, the Royalty would have a defined minimum or maximum “fixed” value. Again this comes at the loss of some flexibility, but would ensure that Owners are not allowing their Samples to be Sold for very small dollar amounts. Still more embodiments would allow the Artist to Sell New Work whose Royalty exceeded the Sale Price, if the New Work is viewed as a “loss leader” by the Artist.
6. In the preferred embodiment, percentages over 100% cannot be returned because all Marked Sample values are ultimately placed in relation to one another. However, percentages greater than 100% are possible, if an unacceptable amount of Content is used. In this case, when the Valuation is returned, it is possible that the Application will prevent the Artist from proceeding if the Valuation exceeds 100%, or some other acceptable range of royalties. Penalties, including barring the Artist from any further downloads, are possible if abuse occurs. In an alternate embodiment, the Artist provides a means by which his Device is randomly scanned by the Application and if the Artist violates any of the terms, the Application could delete the Content from his Device. The Application could also selectively monitor the Artist's device and if a valuation over 100% occurs, it could automatically delete the Work matching the same signatures. Still other embodiments could permit the Artist to in fact derive a Royalty of greater than 100%, if the Artist views the New Work as a “loss leader.” However, even here steps would have to be taken to protect the Owners from undue infringement of their Content.
7. The preferred embodiment does not adjust for the very real possibility that the Artist will use only a portion of the downloaded Sample in the New Work (i.e., the Artist downloads a 15-second Sample, but ultimately uses only 5 seconds of the Sample). This factor has not been accounted for due to the additional complexity, but could be taken into account in an alternate embodiment.
8. Once the Final Valuation is returned, the Artist has the option of accepting it, deleting the New Work, or simply never signing the License Agreement document in step (8). In other embodiments, the Application could return an “estimated” Final Valuation prior to acceptance which triggers the Royalty, and the Artist could agree to be “bound” by the ensuing Final Valuation if it falls within an acceptable range. In this scenario, the Royalty would be fixed to the New Work, the New Work would be saved on the Application Server, and the Artist would not be able to delete it permanently. This embodiment appears overly draconian and would frustrate the creative process, but may be required by some Owners who are particularly interested in seeing how their Samples are being used or wish to discourage over-use of Marked Sample “shopping.” In this embodiment, Owners would have access to the New Work at the time the Artist agreed to be “bound” by the ensuing Final Valuation.
9. The preferred embodiment does not contain a widget which shows the Artist the “real” dollar amount of a Royalty in reference to a Sale for a fixed dollar amount (i.e., $2 from a $10 Sale), although a tool like this could easily be installed in an alternate embodiment.

(8) Should the Artist choose to proceed in selling the new musical composition, the Artist signs a license agreement, agreed to by the copyright-holder by reference, which requires submission of some form of invoices to the copyright-holder reflecting the number of sales of the copies of the song which are sold, which reflect the royalty payment.
1. Many different methods of providing invoices from the Artist to the Owner are possible, and only a basic system is described in the preferred embodiment. Alternative embodiments could involve generation of an automatic invoice by the Application which is used by both the Artist and Owner; the “tracking” of Marks as the Artist promulgates the New Work through electronic media, which when a Sale takes place generates an Royalty entry on an invoice submitted by the Application to the Web Portal and saved on the Application Server in both the Artist file, as well as that of all Owners. Many other methods are possible.
2. It is possible that Owners will be hesitant to allow Artists to use their content in an unrestricted manner; they may view certain use of their Content (whether Marked Samples or Original Works) as damaging to their brand, or have concerns regarding the manner by which the Artist will sell the New Work. The Content could be subject to manual review by the Owner prior to sale, and the Artist subject to civil penalties if selling the work in a manner not specified in the License Agreement. Alternate embodiments could correct for these two problems.
3. Other embodiments could provide a means to linking to “Samples” of the Artist's work which are not Sold but, for example, displayed on a promotional webpage, in terms of the number of “hits” the Artist receives. In this case the Royalty could obligate the Artist to provide a link to the site where the New Work is located. Alternatively, if advertisements are presented on the promotional site, the Owners could become entitled to a percentage of the revenue. Or, if the Artist is tracking the users who enter his site and can track their viewing of the page with the Work to a Sale of any Other Work, the Artist might be required to remit a percentage of the Sale of that Other Work. Such embodiments, while certainly capable of being valued in a tracked online environment, are likely too invasive and speculative to result in meaningful valuations, and the cost of implementation may prove too psychologically invasive to any Artist. Nevertheless, they are listed here as possible embodiments.
4. The review by the Owners could be made subject to initial considerations (i.e., owners could initially specify that they did not want their content used when an Artist uses certain criteria, strong language, etc., and no Artist whose Disclosure Form reflected this could download the Content of that Owner). Alternatively, the Owner could review the Artist's proposed New Work subsequent to the uploading. The issue here is whether the Owner would steal the Artist's New Work. This could conceivably be prevented by the Owner's own License Agreement, which would bar that Owner from licensing Marked Samples through the Web Portal if the Owner is found to be infringing on an Artist's New Work. The Owner would have to determine whether stealing an Artist's New Work would be “worth” potentially losing an enormous potential revenue stream. Ultimately, as the Artist is the party who seeks to “Sample” the Owner's Content, which involves some risk. In order to protect against this, all downloads and uploads are saved in the Artist's file, though not necessarily the Owner's file, as an evidentiary measure. Storage of these files may be purged after a certain time, if the Owner accepts the Final Valuation and the Artist Sells the New Work, producing Royalties. In that case, a list of signatures as well as the name of the New Work is saved (presumably the Artist will then be able to use this, in connection with the New Work, as evidence of potential infringement by others). Another protection against this is the fact that the Owner must respond within a specific timeframe. It is possible that a list of ready “alternates” could be presented to the Artist in the case of rejection, in order to speed up the process.
5. For the sake of speed, it is anticipated that the Owner and Artist will initially sign automated forms indicating their own preferences. The Artist may attest to not using the Content for certain enumerated content forms. In alternative embodiments, this process is not automated but performed manually, which is far less time-efficient but may protect against errors on a mass scale.
6. While sale is limited in the preferred embodiment to New Work, it is possible that the New Work will be sold as a “package” involving some New Work and some Other Work. In this case, the Royalty could be made subject to a Mixed New Work Sample Value which returns the adjusted value of the Royalty as a percentage of the relative value of the New Work to the Other Work as part of a Mixed Sale. Alternate embodiments adjust for this contingency.
7. In the preferred embodiment, the Owner does not sign or verify the License Agreement, as this could cause undue delay. However, alternate embodiments could require that the Owner manually or semi-manually sign or verify the License Agreement prior to download.
8. In the preferred embodiment, the Royalty is calculated and invoiced after each Sale through an automatic process. However, many alternate embodiments exist, including, but not limited to, generation of a fixed sum payable at some time interval, manual generation, etc. The method of generation of invoices, and the manner by which those invoices are reduced to a monetized transfer of payments, is beyond the scope of this Invention although systems easily be incorporated into the system and method of the Invention which allow this to occur—such as linking the Owner and Artist Profile information to bank accounts, or secure third party online payment processing accounts, which could process the invoices, convert the figures into monetized transactions, and automatically make transfers from one bank account to another at a specified time interval, or after each Sale.

What is claimed is:

1. A method, embodied in a computer program or series of computer programs available on a web portal linked to a server, which after an owner of a copyright-protected work agrees to a service agreement can be downloaded and installed on the owner's internet-accessible device; which saves that owner's information, including but not limited to the owner's name, email address, and aesthetic information, into a file created on the server designated for the owner; allows the owner to identify and upload a complete rendition or sample of the owner's work, into which is embedded a signature containing some or all of the owner's information; assigns additional initial criteria to each sample or complete work which must be satisfied before any artist browsing the samples on the web portal may view or download that particular sample or complete work; assigns a value to the sample or complete work, where this value is derived from variables including, but not limited to, the aesthetic type of the sample, the total time of sample, the types of sounds used in the sample, the commercial success of the complete work or samples of that work, the commercial success of similar copyright-protected work or samples of that work whether attributable to that owner or otherwise, the number of times the complete work or samples of that work or similar work have been downloaded in any form, the relative value of one sample as compared to all or several of the other samples from the completed work or other samples from other similar completed works or samples, or other values; and saves that assigned value, as well as all other steps taken and agreements entered into in connection with claim 1, on files created on the server.

2. The method of claim 1, where the web portal and server are not a stand-alone system, but are controlled by one or several owners or artists.

3. The method of claim 1, where the program is not downloaded onto the owner's internet-accessible device.

4. The method of claim 1, where the owner's information, or any of the initial criteria or value criteria for any sample or completed work, may be altered by the owner at any time.

5. The method of claim 1, where any owner may exclude any of its samples or completed works from comparison with any other samples or completed works, whether or not those other samples or completed works are owned by the same owner.

6. The method of claim 1, where assignment of any or all value criteria is automated.

7. A method, embodied in a computer program or series of computer programs available on a web portal linked to a server, which after an artist agrees to a service agreement can be downloaded and installed on the artist's internet-accessible device; saves specified artist information, including but not limited to artist's name, email address, aesthetic characteristics, or commercial information, into a file created on the server designated for the artist; compares the artist's information saved in the artist's file against the additional initial criteria provided by all owners described in claim 1; allows the artist to access and listen to all samples or complete works whose initial criteria as described in claim 1 is positively correlated with the artist's information; provides a range of potential values for each sample or aggregate list of samples which the artist accesses; requires the artist to agree to download, store, incorporate, re-upload, or dispose all samples or complete works viewable by that artist in a particular manner; permits the artist to download these samples and incorporate the digital files of these downloaded samples into a new digital work; and permits the artist to upload the new digital work containing these incorporated samples onto the server through the web portal; and saves all steps, agreements, and lists of samples accessed by, listened to, and downloaded by the artist in connection with claim 7, in files created on the server.

8. The method of claim 7, where the artist's aesthetic, commercial, or other information may be changed by the artist at any time.

9. The method of claim 7, where the artist does not provide any or all any aesthetic, commercial, or other information as a precondition for browsing, listening to, or obtaining value information for, samples or completed works.

10. The method of claim 7, where the value of each sample or the aggregate value of multiple samples viewed by the artist is not provided as a range of values, but as a specific value or aggregate value.

11. The method of claim 7, where the artist downloads a completed work and subsequently manually extracts samples for use in a new work.

12. The method of claim 7, where the artist does not download samples, but incorporates them into new works using a computer program linked to the server and available through the web portal.

13. A method, embodied in a computer program or series of computer programs available on a web portal linked to a server, which analyzes the artist's uploaded new digital work described in claim 7 and locates any owner's information signature embedded into the owner's samples described in claim 1; compiles a list of all samples containing an embedded owner information signatures which are present in the artist's new work; allows the artist to elect to perform a calculation which retrieves the values assigned by the owner to each sample described in claim 1 and contained on the compiled list, and sets these original values in relation to each sample's presence in the artist's new digital work, where this relationship may include, but is not limited to, the commercial data available for the artist, the aesthetic reputation of the artist, the number of samples used by the artist in the new digital work, the type of samples used by the artist in the new digital work, the total time of all samples used in the new digital work, the percentage of each downloaded sample actually used in the new digital work, or other values, and returns a new value reflecting this comparative relationship; allows the artist to confirm that a copy of the new digital work will contain the selected samples at the specified compared values; allows the artist to specify that the new digital work will only be used, distributed, made available, or sold in a particular manner; generates the aggregate value reflecting all portions of all samples of all owners' work contained in the new digital work; apportions this aggregate value among all owners whose work is now contained in the artist's new digital work; and saves a copy of both the aggregate and disaggregated valuations in the files of both the artist who created the new digital work and all the owners whose samples were incorporated into the artist's new digital work, as well as a copy of all steps completed and agreements entered into in connection with claim 13, in files created on the server.

14. The method of claim 13, where an owner whose sample was used in the artist's new digital work is permitted to access that new digital work regardless whether the artist confirms that the new digital work will contain the selected samples at their specified compared values, or agrees that the new digital work will only be used, distributed, made available, or sold in a particular manner.

15. The method of claim 13, where the artist need not specify either that the new digital work will contain the selected samples at their specified compared values, or agrees that the new digital work will only be used, distributed, made available, or sold in a particular manner, or both.

16. A method, embodied in a computer program or series of computer programs available on a web portal linked to a server, which allows the artist who created the new digital work described in claim 7 which was made subject to the conditions of claim 13 to download and agree to terms and conditions for remitting invoices, website page view histories, or other information positively correlated with the artist's new digital work to the web portal linked to the server; distributes any invoices, website page view histories, or other information remitted by the artist to the files of all owners described in claim 1 whose samples were incorporated by the artist into the new digital work; derives a value from the invoices, website page view histories, or other information; apportions that value to all owners described in claim 1 whose samples were incorporated into the artist's new digital work; saves a copy of all apportioned values in the files of those owners; and
saves a copy of all steps completed and agreements entered into in connection with claim 16, in files created on the server.

17. The method of claim 16, where the invoices, website page view histories, or other information positively correlated with the artist's new digital work is automatically sent to the server linked to the web portal upon the happening of a specified event, such as a sale of an electronic copy of the artist's new digital work, or the viewing of a specified web page, or other occurrence.

18. The method of claim 16, where the value from any, or several, of the uploaded invoices, website page view histories, or other information positively correlated with the artist's new digital work is remitted through the web portal to the server either at fixed intervals, or when specific value thresholds are reached.

19. The method of claim 16, where the owner may foreclose the sale or distribution of the artist's new digital work which contains some portion of the owner's samples if that artist fails to use, distribute, make available, or sell the new digital work in the particular manner described in claim 13.

20. The aggregate method of claims 1, 7, 13, and 16, where performance of any step or process of any claimed method, or access to any calculation or product of any claimed method, is made subject to manual or automatic performance or access by an entity which is not an owner described in claim 1, or an artist described in claim 7.

21. The aggregate method of claims 1, 7, 13, and 16, where the valuation derived from any step of any claim is correlated with and represented by any recognizable currency, exchange, language, or form.

22. The aggregate method of claims 1, 7, 13, and 16.
